(19) United States
(12) Patent Application Publication
(10) Pub. No.: US 2025/0210697 A1
(43) Pub. Date: Jun. 26, 2025

(54) COMPOSITE SOLID-STATE ELECTROLYTE, METHOD OF PREPARING THE SAME, AND LITHIUM BATTERY COMPRISING THE SOLID-STATE ELECTROLYTE

(71) Applicant: Samsung Electronics Co., Ltd., Suwon-si (KR)

(72) Inventors: Taeyoung Kim, Suwon-si (KR); Giyun Kwon, Suwon-si (KR); Youngjoon Bae, Suwon-si (KR); Jeongkuk Shon, Suwon-si (KR); Heungchan Lee, Suwon-si (KR)

(21) Appl. No.: 18/985,549

(22) Filed: Dec. 18, 2024

(30) Foreign Application Priority Data
Dec. 20, 2023 (KR) 10-2023-0187566

(51) Int. Cl. H01M 10/0562; H01M 10/0525

(52) U.S. Cl. CPC H01M 10/0562; H01M 10/0525; H01M 2300/0077

(57) ABSTRACT

A composite solid-state electrolyte, a method of preparing the same, and a lithium battery including the same. The composite solid-state electrolyte includes a first solid-state electrolyte including a cubic garnet phase and a pyrochlore phase, and a second solid-state electrolyte including a glass phase, and a volume of the first solid-state electrolyte is greater than that of the second solid-state electrolyte, based on a total volume of the composite solid-state electrolyte.

### CROSS-REFERENCE TO RELATED APPLICATION

This application is based on and claims priority to Korean Patent Application No. 10-2023-0187566, filed on Dec. 20, 2023, in the Korean Intellectual Property Office, and all the benefits accruing therefrom under 35 U.S.C. § 119, the content of which is herein incorporated by reference in its entirety.

### BACKGROUND

### 1. Field

The disclosure relates to a composite solid-state electrolyte, a method of preparing the same, and a lithium battery including the same.

### 2. Description of the Related Art

Lithium batteries may provide increased specific energy (watt-hour per kilogram, Wh/kg) and/or energy density (watt-hour per cubic centimeter, Wh/cc).

Lithium batteries may include a solid electrolyte to improve stability. By using a solid electrolyte, the risk of fire may be reduced and a manufacturing process may be simplified.

Among solid electrolytes, garnet-type oxide solid electrolytes, with high ionic conductivity, are known as important materials of oxide all-solid secondary batteries due to their excellent chemical stability against lithium metal. Although a garnet-type oxide solid electrolyte has a high theoretical Li ion conductivity, because the electrolyte is an oxide-containing material, a densification process performed by sintering at a high temperature of about 1200° C. is generally required to provide the excellent Li ion conductivity. Various sintering agents have been introduced in efforts to decrease the sintering temperature for the material. However, the use of these sintering agents may provide a limited reduction of the sintering temperature. Furthermore, the simultaneous use of the garnet-type oxide solid electrolyte and the sintering agents may cause issues such as the formation of additional interfaces and side reactions.

A need remains for methods to provide composite solid-state electrolytes sintered at low temperatures while maintaining conductivity properties.

### SUMMARY

Provided is a composite solid-state electrolyte sintered at a low temperature and having a high conductivity.

Provided is a lithium battery including the composite solid-state electrolyte.

Provided is a method of preparing the composite solid-state electrolyte.

Additional aspects will be set forth in part in the description which follows and, in part, will be apparent from the description, or may be learned by practice of the presented embodiments.

According to an aspect of the disclosure, a composite solid-state electrolyte includes a first solid-state electrolyte including a cubic garnet phase and a pyrochlore phase and a second solid-state electrolyte including a glass phase, wherein a volume of the first solid-state electrolyte is greater than that of the second solid-state electrolyte, based on a total volume of the composite solid-state electrolyte.

The ratio of the cubic garnet phase to the pyrochlore phase may be about 99.5:0.5 to about 3:2.

A crystallization temperature T1 of the first solid-state electrolyte may be less than a crystallization temperature T2 of the second solid-state electrolyte.

The crystallization temperature of the first solid-state electrolyte may be about 300° C. to about 450° C., and the crystallization temperature of the second solid-state electrolyte may be about 450° C. to about 600° C., about 450° C. to about 550° C., or about 450° C. to about 500° C.

The composite solid-state electrolyte may be a heat treatment product of a composite solid-state electrolyte-forming composition, i.e., a mixture of a first solid-state electrolyte precursor and a second solid-state electrolyte precursor. A heat treatment temperature T of the composite solid-state electrolyte-forming composition may be 550° C. or less, and the crystallization temperature T1 of the first solid-state electrolyte, the heat treatment temperature T of the composite solid-state electrolyte-forming composition, and the crystallization temperature T2 of the second solid-state electrolyte may satisfy Expression 1,

T1<T<T2. Expression 1

The composite solid-state electrolyte has a structure in which the second solid-state electrolyte is dispersed in pores of a matrix formed of the first solid-state electrolyte.

A crystal phase of the first solid-state electrolyte may have a size of about 50 nanometers (nm) to about 50 micrometers (μm). In addition, the composite solid-state electrolyte may have an ionic conductivity of about 1×10⁻⁶ siemens per centimeter (S/cm) to about 1×10⁻³ S/cm and a relative density of about 80% to about 95% based on a theoretical density of the composite solid-state electrolyte.

The composite solid-state electrolyte may have a thickness of about 1 μm to about 500 μm.

In the composite solid-state electrolyte, an amount of the first solid-state electrolyte may be greater than 50 volume percent (vol %) and 99 vol % or less based on a total volume of the composite solid-state electrolyte.

The first solid-state electrolyte may include a compound represented by Formula 1.

(LiₓAₐ)(La_{y}B′_{b})(Zr_{z}C′_{c})O₁₂ Formula 1

In Formula 1, A may be a monovalent, divalent, or trivalent cation, or a combination thereof, B′ may be a monovalent, divalent, or trivalent cation, or a combination thereof, C′ may be a monovalent cation, a divalent cation, a trivalent cation, a tetravalent cation, a pentavalent cation, a hexavalent cation, or a combination thereof, 6≤x≤8, 0≤a≤2, 2≤y≤3, 0≤b≤1, 0<z≤2, and 0≤c≤2.

The compound represented by Formula 1 may include a compound represented by Formula 3 or 4.

(LiₓAₐ)(La_{y})(Zr_{z})O₁₂ Formula 3

In Formula 3, A may include at least one of Ga or Al, 6≤x≤8, 0≤a≤2, 2≤y≤3, and 0<z≤2.

Li₃₊ₓLa₃Zr₂₋ₐC′ₐO₁₂ Formula 4

In Formula 4, C′ may include at least one of aluminum (Al), tungsten (W), niobium (Nb) or tantalum (Ta), 3≤x≤5 and 0≤a≤0.7.

The second solid-state electrolyte may be an oxide glass including lithium (Li), oxygen (O), and at least one of germanium (Ge), silicon (Si), boron (B), or phosphorus (P).

The second solid-state electrolyte may be a glass including SiO₂, B₂O₃, and Li₂O, wherein an amount of the Li₂O may be 20 mol % to 75 mol %, an amount of the SiO₂ may be more than 0 mol % to 70 mol %, and an amount of the B₂O₃ may be more than 0 mol % to 60 mol %.

When analyzed by X-ray diffraction (XRD) using CuKa radiation of the composite solid-state electrolyte, peaks related to the pyrochlore phase are observed in diffraction angles of about 27.5°2θ to about 29°2θ, about 32°2θ to about 33.5°2θ, about 46.5°2θ to about 48° 2θ, and about 55°2θ to about 56.5° 2θ.

According to another aspect of the disclosure, a lithium battery includes a positive electrode, a negative electrode, and an electrolyte layer disposed between the positive electrode and the negative electrode, wherein at least one of the positive electrode, the negative electrode, or the electrolyte layer includes the above-described composite solid-state electrolyte. The lithium battery may be a lithium-ion battery, an all-solid secondary battery, or a lithium air battery, wherein the all-solid secondary battery may be, for example, a multilayer ceramic capacitor (MLC).

The positive electrode may include the above-described composite solid-state electrolyte.

The positive electrode of the lithium battery may include a first solid-state electrolyte including a cubic garnet phase and a pyrochlore phase and a second solid-state electrolyte including a glass phase. The volume of the first solid-state electrolyte may be greater than a volume of the second solid-state electrolyte, based on the total volume of the composite solid-state electrolyte.

According to another aspect of the disclosure, a method of preparing a composite solid-state electrolyte including a first solid-state electrolyte and a second solid-state electrolyte, includes mixing a first solid-state electrolyte precursor including an amorphous phase and a second solid-state electrolyte precursor including a glass phase to prepare a composite solid-state electrolyte-forming composition, and heat-treating the composite solid-state electrolyte-forming composition to prepare the composite solid-state electrolyte. The first solid-state electrolyte includes a cubic garnet phase and a pyrochlore phase and the second solid-state electrolyte includes a glass phase, and a volume of the first solid-state electrolyte is greater than a volume of the second solid-state electrolyte, based on the total volume of the composite solid-state electrolyte.

The heat-treating of the composite solid-state electrolyte-forming composition may be performed at 550° C. or less. The heat-treating of the composite solid-state electrolyte-forming composition may be performed at a temperature greater than a crystallization temperature of a first solid-state electrolyte precursor and less than a crystallization temperature of a second solid-state electrolyte precursor.

The second solid-state electrolyte may include a glass phase including an oxide glass including lithium (Li), oxygen (O), and at least one of germanium (Ge), silicon (Si), boron (B), or phosphorus (P).

The second solid-state electrolyte may be a glass including SiO₂, B₂O₃, and Li₂O, wherein an amount of the Li₂O may be about 20 mole percent (mol %) to about 75 mol %, an amount of the SiO₂ may be greater than 0 mol % to about 70 mol %, and an amount of the B₂O₃ may be greater than 0 mol % to about 60 mol %.

In addition, the composite solid-state electrolyte may include a heat treatment product of the composite solid-state electrolyte-forming composition, a heat treatment temperature T of the composite solid-state electrolyte-forming composition may be 550° C. or less, a heat treatment temperature T of the composite solid-state electrolyte may be 550° C. or less, and a crystallization temperature T1 of the first solid-state electrolyte, a sintering temperature T of the heat treatment temperature T of the composite solid-state electrolyte-forming composition, and a crystallization temperature T2 of the second solid-state electrolyte may satisfy Expression 1.

T1<T<T2. Expression 1

### BRIEF DESCRIPTION OF THE DRAWINGS

The above and other aspects, features, and advantages of certain embodiments will be more apparent from the following description taken in conjunction with the accompanying drawings, in which:

FIG. 1 is a diagram schematically illustrating an embodiment of a structure of a composite solid-state electrolyte;

FIG. 2A is a graph illustrating intensity (arbitrary units, a.u.) versus diffraction angle (degrees 2θ) of an X-ray diffraction (XRD) analysis using CuKa rays for the amorphous first solid-state electrolyte prepared in Preparation Example 1 (top plot) and the precursor having a pyrochlore crystal phase prepared in Preparation Example 1 (bottom plot);

FIG. 2B is a graph illustrating heat flow (a.u., with endothermic peaks pointing up) versus temperature (degrees, ° C.) of a differential scanning calorimetry (DSC) analysis of an amorphous first solid-state electrolyte precursor and a glass phase-second solid-state electrolyte of Example 1 and a sintered product prepared in Comparative Example 1;

FIG. 2C is graph illustration intensity (a.u.) versus diffraction angle (degrees 2θ) of an XRD analysis using CuKa rays for the composite solid-state electrolytes of Examples 1 to 3, the composite solid-state electrolyte of Comparative Example 4, LLZTO having a cubic garnet phase, and LZT having a pyrochlore phase.

FIGS. 3A, 3B, 3C, and 3D are micrographs of the scanning electron microscopy/energy dispersive X-ray spectroscopy (SEM-EDS) analysis of the composite solid-state electrolytes prepared in Examples 1 to 3 and Comparative Example 4;

FIGS. 4A, 4B, 4C, and 4D are micrographs of the (SEM-EDS) analysis of the composite solid-state electrolyte prepared according to Example 1;

FIG. 5 is a diagram schematically illustrating an embodiment of a lithium battery;

FIG. 6 is a diagram schematically illustrating an embodiment of a lithium battery;

FIG. 7 is a diagram schematically illustrating an embodiment of a lithium battery;

FIG. 8 is a diagram schematically illustrating an embodiment of a structure of an all-solid secondary battery;

FIG. 9 is a diagram schematically illustrating another embodiment of a structure of an all-solid secondary battery;

FIG. 10 is a diagram schematically illustrating another embodiment of a structure of an all-solid secondary battery;

FIG. 11 is a diagram schematically illustrating an embodiment of a structure of a multilayer ceramic battery;

FIG. 12 is a diagram schematically illustrating another embodiment of a structure of a multilayer ceramic battery; and

FIG. 13 is a diagram schematically illustrating another embodiment of a structure of a multilayer ceramic battery.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

The disclosure described below allows for various changes and numerous embodiments, particular embodiments will be illustrated in the drawings and described in detail in the written description. However, this is not intended to limit the disclosure to particular modes of practice, and it is to be appreciated that all modifications, equivalents, and substitutes that do not depart from the spirit and technical scope of the disclosure are encompassed in the disclosure.

Unless otherwise stated in the specification, it will be understood that when one element such as layer, film, region, or plate, is referred to as being “on” another element, it may be directly on the other element, or intervening elements may also be present therebetween.

Furthermore, relative terms, such as “lower” or “bottom” and “upper” or “top,” may be used herein to describe one element's relationship to another element as illustrated in the Figures. It will be understood that relative terms are intended to encompass different orientations of the article in addition to the orientation depicted in the Figures. For example, if the article in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the article in one of the figures is turned over, elements described as “below” or “beneath” other elements would then be oriented “above” the other elements. The terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Unless otherwise stated in the specification, an expression used in the singular may encompass the expression of the plural. Unless otherwise stated, the term “A or B” may refer to “including A, including B, or including both A and B”.

As used herein, the term “a combination thereof” may refer to a mixture, a stack structure, a composite, a copolymer, an alloy, a blend, and a reaction product of components.

As used herein, garnet is a silicate that can be referred to using the formula X₃Y₂ (SiO₄)₃, wherein X is a divalent cation, and Y is a trivalent cation. As used herein, the term “cubic garnet” or “garnet structure” means that the compound has cubic symmetry and is isostructural with garnet, e.g., Mg₃Al₂(SiO₄)₃.

As used herein, pyrochlore is a niobium oxide that can be referred to using the formula (NaₐCaₐ₋₁)₂Nb₂O₆ (OH_{b}F_{b-1}), wherein 0≤a≤1 and 0≤b≤1. As used herein, the term “pyrochlore phase” means that the compound is isostructural with pyrochlore.

Throughout the specification, the particle diameter may be an average particle diameter, unless otherwise defined. The particle diameter may refer to an average particle diameter (D50) indicating a particle diameter corresponding to 50% of the particles in a cumulative distribution curve. The D50 may be measured by any method well known in the art, for example, using a particle size analyzer, or using a transmission electron microscope (TEM) or a scanning electron microscope (SEM). In other embodiments, the D50 value may be obtained by measuring diameters of particles by dynamic light-scattering, counting the number of particles belonging to each particle diameter range via data analysis, and calculating the results. D50 may also be measured by a laser diffraction method. By the laser diffraction method, particles to be measured may be dispersed in a dispersion medium and ultrasonic waves of about 28 kilohertz (kHz) were emitted thereto at an output of 60 watts (W) using a commercially available laser diffraction particle diameter measuring device (e.g., MT 3000 manufactured by Microtrac), and then an average particle diameter (D50) may be calculated based on 50% of the particle size distribution in the measuring device.

The terms used herein are merely used to describe particular embodiments and are not intended to limit the disclosure. An expression used in the singular encompasses the expression of the plural, unless it has a clearly different meaning in the context. In the specification, it is to be understood that the terms such as “including” or “having” etc., are intended to indicate the existence of the features, numbers, processes, elements, parts, components, materials, or combinations thereof disclosed in the specification, and are not intended to preclude the possibility that one or more other features, numbers, processes, elements, parts, components, materials, or combinations thereof may exist or may be added. As used herein, the “/” may be interpreted as either “and” or “or” depending on situations.

In the drawings, thicknesses of various layers and regions may be enlarged or reduced for clarity. Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims. Throughout the specification, like reference numerals denote like elements. Throughout the specification, it will be understood that when one element such as layer, film, region, or plate, is referred to as being “on” another element, it may be directly on the other element, or intervening elements may also be present therebetween. Although the terms first, second, etc. may be used herein to describe various components, these components should not be limited by these terms. These terms are only used to distinguish one component from another.

In the disclosure, the term “metal” includes metals and metalloids such as silicon and germanium in an elemental or ionic state.

In the disclosure, the term “alloy” refers to a combination of two or more metals.

In the disclosure, the term “positive active material” refers to a material for positive electrodes allowing lithiation and delithiation.

In the disclosure, the term “negative active material” refers to a material for negative electrodes allowing lithiation and delithiation.

In the disclosure, the terms “lithiation” and “lithiating” refer to a process of adding lithium to a positive active material or a negative active material.

In the disclosure, the terms “delithiation” and “delithiating” refer to a process of removing lithium from a positive active material or a negative active material.

In the disclosure, the terms “charging” and “charge” refer to a process of supplying electrochemical energy to a battery.

In the disclosure, the terms “discharging” and “discharge” refer to a process of removing electrochemical energy from a battery.

In the disclosure, the terms “positive electrode” and “cathode” refer to an electrode in which electrochemical reduction and lithiation occur during discharging.

In the disclosure, the terms “negative electrode” and “anode” refer to an electrode in which electrochemical oxidation and delithiation occur during discharging.

In the disclosure, the term “isostructural” refers to crystal structures of chemical compounds. The crystal structures are the same, but the cell dimensions and/or the chemical composition may not be the same.

In the disclosure, the “particle diameter” or “particle size” of particles may indicate an average diameter of spherical particles or an average length of major axes of non-spherical particles. In the disclosure, the “crystal phase size” may indicate an average diameter of spherical particles or an average length of major axes of non-spherical particles. In the disclosure, average length of major axes may be measured through scanning electron microscope image analysis. Particle diameters of particles may be measured using a particle size analyzer (PSA). The “particle diameter” of particles may be, for example, an average particle diameter. The average particle diameter may be, for example, a median particle diameter D50 unless otherwise stated. The median particle diameter D50 may refer to a particle size corresponding to a 50% cumulative value in a cumulative distribution curve in which particles are accumulated in the order of particle diameter from the smallest particle to the largest particle. The cumulative value may be, for example, a cumulative volume. The median particle diameter D50 may be measured, for example, by a laser diffraction method.

If measured by using an SEM, an average value of more than 30 randomly selected particles having a diameter of 1 micrometers (μm) or greater, excluding fine particles, may be used.

The average particle diameter of the positive active material may be measured, for example, by a laser diffraction method, more particularly, by dispersing the positive active material in a solution, emitting ultrasonic waves of about 28 kHz at an output of 60 W using a commercially available laser diffraction particle diameter measuring device (e.g., Microtrac MT 3000), and then calculating an average particle diameter D50 based on 50% of the particle size distribution in the measuring device.

As used herein, the term “D10” may refer to an average particle diameter corresponding to 10% of the particles in a cumulative distribution curve, and “D90” may refer to an average particle diameter corresponding to 90% of the particles in a cumulative distribution curve.

Hereinafter, the composite solid-state electrolyte, a method of preparing the same, and a lithium battery including the same according to an embodiment will be described in more detail.

In the case of preparing a lithium battery using a NASICON solid electrolyte, there are limits to select electrode active materials and energy density of the lithium battery may deteriorate due to a relatively high sintering temperature of about 700° C. and a low reduction potential window. Accordingly, a method of using glass solid electrolytes instead of NASICON solid electrolytes has been proposed. Although various electrode active materials may be used as the glass solid electrolytes, the glass solid electrolytes have low conductivity, and thus improvement in conductivity may be required.

Although the garnet-type oxide solid electrolyte has a high room-temperature conductivity, a sintering process at a high temperature is typically required for connection between particles due to hardness of the oxide material. However, a secondary phase with high resistance may be formed in response to reaction with an active material or deterioration of materials of the active material and the electrolyte may occur during the high-temperature sintering process. Therefore, it is desirable to decrease the heat treatment temperature to a level where the oxide solid electrolyte does not react with the active material. However, due to insufficient particles connections at the decreased heat treatment temperature, ionic conductivity of the garnet-type oxide solid electrolyte may significantly decrease. High conductivity of the garnet-type crystalline electrolyte can be maintained by adding a material capable of forming an interface at a low temperature.

Accordingly, by solving the above-mentioned problems, a composite solid-state electrolyte sintered at a lower temperature and having a higher conductivity compared to the garnet-type oxide solid electrolyte may be provided. By using the composite solid-state electrolyte, side reactions with an electrode active material do not occur and various electrode active materials may be used.

### Composite Solid-State Electrolyte

The composite solid-state electrolyte according to an embodiment may include a first solid-state electrolyte including a cubic garnet phase and a pyrochlore phase and a second solid-state electrolyte including a glass phase, wherein a volume of the first solid-state electrolyte may be greater than that of the second solid-state electrolyte, based on a total volume of the composite solid-state electrolyte.

The composite solid-state electrolyte may include a first solid-state electrolyte including a cubic garnet phase and a pyrochlore phase and a glass-phase second solid-state electrolyte after sintering an amorphous first solid-state electrolyte precursor and a glass-phase second solid-state electrolyte precursor. By adjusting the sintering temperature of the composite solid-state electrolyte between the crystallization temperature of the first solid-state electrolyte and the crystallization temperature of the second solid-state electrolyte, a composite solid-state electrolyte with increased conductivity and density may be prepared at a low temperature. By using the composite solid-state electrolyte, sintering may be performed at a low temperature and a lithium battery with increased energy density may be prepared. By using such a solid-state electrolyte, a lithium battery with improved cycle characteristics may be provided.

The first solid-state electrolyte has high conductivity, and the second solid-state electrolyte has good deformability.

While the amorphous first solid-state electrolyte precursor is going through a crystallization process, particles may be interconnected, and the glass-phase second solid-state electrolyte may be introduced into gaps between the particles of the first solid-state electrolyte. Via the crystallization process of the amorphous first solid-state electrolyte precursor, interfacial resistance between particles may decrease to provide a composite solid-state electrolyte with improved ionic conductivity. The crystallization temperature of the first solid-state electrolyte may be less than the crystallization temperature of the second solid-state electrolyte. The heat treatment temperature, i.e., sintering temperature, of the composite solid-state electrolyte-forming composition including the amorphous first solid-state electrolyte precursor and the glass-phase second solid-state electrolyte precursor may be greater than the crystallization temperature of the first solid-state electrolyte and less than the crystallization temperature of the second solid-state electrolyte.

The heat treatment temperature, i.e., sintering temperature T, of the mixture of the first solid-state electrolyte precursor and the second solid-state electrolyte precursor used to prepare the composite solid-state electrolyte may be 550° C. or less, and the crystallization temperature T1 of the first solid-state electrolyte, the heat treatment temperature, i.e., the sintering temperature T, of the composite solid-state electrolyte-forming composition and the crystallization temperature T2 of the second solid-state electrolyte may satisfy Expression 1.

$$T 1 < T < T 2 \qquad Expression 1$$

The heat treatment temperature, i.e., sintering temperature T, of the mixture of the first solid-state electrolyte precursor and the second solid-state electrolyte precursor used to prepare the composite solid-state electrolyte may be 550° C. or less, 500° C. or less, or about 350° C. to about 500° C. A heat treatment time of the mixture of the first solid-state electrolyte precursor and second solid-state electrolyte precursor may vary according to the heat treatment temperature but may be, for example, about 10 minutes to about 2 hours. The crystallization temperature T1 of the first solid-state electrolyte may be about 300° C. to about 450° C., about 350° C. to about 430° C., or about 380° C. to about 420° C., and the crystallization temperature T2 of the second solid-state electrolyte may be above 450° C., 500° C. or greater, or about 500° C. to about 550° C.

When the crystallization temperature T1 of the first solid-state electrolyte, the sintering temperature T, and the crystallization temperature T2 of the second solid-state electrolyte are within the ranges, a composite solid-state electrolyte with improved sintering characteristics at a low temperature and improved ionic conductivity may be prepared.

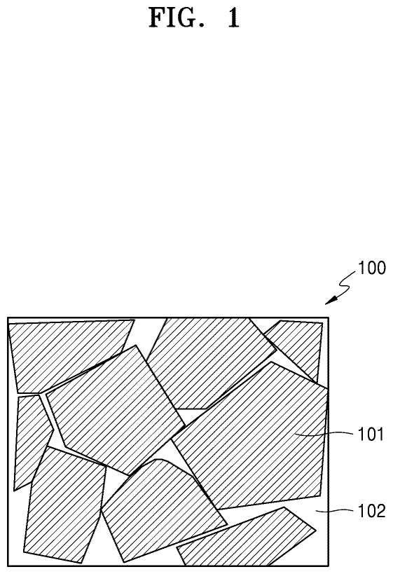

Referring to FIG. 1, a composite solid-state electrolyte 100 may include a highly conductive first solid-state electrolyte 101 including a cubic garnet crystal phase and a pyrochlore phase and a second solid-state electrolyte 102 including a glass phase. The glass-phase second solid-state electrolyte 102 has flexibility. The glass-phase second solid-state electrolyte 102 connects particles of the first solid-state electrolyte 101 and fills gaps between particles of the first solid-state electrolyte 101. By having such a structure, the composite solid-state electrolyte may have high conductivity and density.

An amount of the second solid-state electrolyte according to an embodiment may be less than 50 volume percent (vol %) or about 1 vol % to about 45 vol % based on a total volume of the composite solid-state electrolyte. An amount of the second solid-state electrolyte according to another embodiment may be 10 vol % or less or about 1 vol % to about 10 vol %. A mixing volume ratio of the first solid-state electrolyte to the second solid-state electrolyte may be about 99:1 to about 55:45 (1.2:1) or about 95:5 to about 60:40 (1.5:1).

When the amount of the second solid-state electrolyte is within the ranges described above, the composite solid-state electrolyte may be sintered at a low temperature and may have a high conductivity of 1×10⁻⁵ siemens per centimeter (S/cm) or greater, for example, about 1×10⁻⁵ S/cm to about 1×10⁻³ S/cm, at room temperature (e.g., at about 25° C.).

A particle size of the first solid-state electrolyte precursor in an amorphous state may be about 10 nanometers (nm) to about 1 micrometer (μm). After heat treatment, the size of the crystal phase of the first solid-state electrolyte may be about 50 nm to about 50 μm, about 100 nm to about 30 μm, or about 500 nm to about 20 μm. As the size of the crystal phase of the sintered product obtained by heat treatment increases, ionic conductivity of the composite solid-state electrolyte may increase. In this regard, the size of the crystal phase indicates an average diameter of spherical particles or an average length of major axes of non-spherical particles.

The composite solid-state electrolyte may have a relative density of about 80% to about 95%, about 83% to about 93%, or about 83.5% to about 91%, based on a theoretical density of the composite solid-state electrolyte. When the relative density of the composite solid-state electrolyte is within the ranges, dense composite solid-state electrolyte may be obtained.

The composite solid-state electrolyte may have a thickness of about 1 μm to about 500 μm, about 1 μm to about 300 μm, or about 3 μm to about 20 μm.

The first solid-state electrolyte may include, a material including Li, La, Zr, Ta, or O. In addition, the second solid-state electrolyte may include a glass material with a glass transition phenomenon and including Li, B, Si, or O. The first solid-state electrolyte may have a greater Li content than that of the second solid-state electrolyte.

The heat treatment of the first solid-state electrolyte precursor and the second solid-state electrolyte precursor used to the composite solid-state electrolyte may be performed at about the crystallization temperature of the first solid-state electrolyte to about the crystallization temperature of the second solid-state electrolyte. After performing the heat treatment in the temperature range, the composite solid-state electrolyte may include a first solid-state electrolyte, which includes the cubic garnet phase as a main phase and the pyrochlore phase as a part, and a second solid-state electrolyte including the glass phase.

The first solid-state electrolyte may include, for example, a compound represented by Formula 1.

(LiₓAₐ)(La_{y}B′_{b})(Zr_{z}C′_{c})O₁₂ Formula 1

In Formula 1, A may be a monovalent cation, a divalent cation, a trivalent cation, or a combination thereof,
B′ may be a monovalent cation, a divalent cation, a trivalent cation, or a combination thereof,
C′ may be a monovalent cation, a divalent cation, a trivalent cation, a tetravalent cation, a pentavalent cation, a hexavalent cation, or a combination thereof,
6≤x≤8, 0≤a≤2, 2≤y≤3, 0≤b≤1, 0<z≤2, and 0≤c≤2.

In Formula 1, the monovalent cation of A, B′, and C′ may include at least of Li, Na, or K. The divalent to hexavalent cation may include, for example, at least of Mg, Ca, Sr, Sc, Y, La, Ce, Pr, Nd, Sm, Eu, Gd, Tb, Dy, Ho, Er, Tm, Yb, Lu, Zr, Hf, V, Nb, Ta, Mo, W, Mn, Tc, Re, Fe, Ru, Os, Co, Rh, Ir, Ni, Pd, Pt, Cu, Ag, Au, Zn, Cd, Hg, Al, Ga, In, Tl, Ge, Sn, Pb, Sb, Bi, Po, As, Se, or Te.

In Formula 1, 6.1≤x≤8, 6.3≤x≤8, 6.5≤x≤8, or 6.7≤x≤8, and 0≤a≤2, 0.5≤a≤1.8, 0.7≤a≤1.8, or 1≤a≤2.

In Formula 1, 2≤y≤3, 2.3≤y≤3, 2.5≤y≤3, or 2.7≤y≤3, and 0≤b≤1, 0.3≤b≤1, 0.5≤b≤1, or 0.7≤b≤1.

In Formula 1, 0<z≤2, 0.3≤z≤2, 0.5≤z≤2, or 0.7≤z≤2, and 0≤c≤2, 0.3≤c≤2, 0.5≤c≤2, or 0.7≤c≤2.

The composite solid-state electrolyte according to an embodiment may include a garnet-type crystal phase and a pyrochlore phase. In the XRD spectrum of the composite solid-state electrolyte, peaks are observed at diffraction angles of about 16.8° 2θ±0.5°, about 17.5°2θ to about 19° 2θ, about 26°2θ to about 28° 2θ, about 33°2θ to about 35° 2θ, about 46°2θ to about 48° 2θ. In the XRD spectrum of the composite solid-state electrolyte, peaks are observed at diffraction angles of about 27.5°2θ to about 29° 2θ, about 32°2θ to about 33.5° 2θ, about 46.5°2θ to about 48° 2θ, and about 55°2θ to about 56.5° 2θ. In this regard, the peaks observed at the diffraction angles of about 16.8° 2θ+0.5°, about 17.5° 2θ to about 19°2θ, about 26°2θ to about 28° 2θ, about 33°2θ to about 35° 2θ, and about 46° 2θ to about 48°2θ are peaks related to the cubic garnet phase, and the peaks observed at the diffraction angles of about 27.5°2θ to about 29°2θ, about 32°2θ to about 33.5° 2θ, about 46.5°2θ to about 48° 2θ, and about 55°2θ to about 56.5°2θ are peaks related to the pyrochlore phase.

The composite solid-state electrolyte according to an embodiment is in a tetragonal phase-free state. In this state, the peak at a diffraction angle of 16.8° 2θ+0.5° of the XRD spectrum of the composite solid-state electrolyte has a singlet pattern.

Because deformity may be improved as described above, the composite solid-state electrolyte may be formed in various shapes at a low temperature. In addition, because the composite electrolyte may be formed at a low temperature, deformity may decrease in the case of being coupled with a structure such as an electrode, thereby stabilizing interfacial properties of the composite solid-state electrolyte and the structure.

In the composite solid-state electrolyte, the amounts of the cubic garnet crystal phase and the pyrochlore phase, and the mixing ratio thereof may be directly or indirectly identified by XRD analysis or transmission electron microscopy/selected area electron diffraction (TEM/SAED). The mixing ratio of the respective crystal phases may be determined by performing XRD Rietveld analysis for the selected crystal phases in an acquired XRD spectrum.

The composite solid-state electrolyte according to an embodiment including the cubic garnet phase, the pyrochlore phase, and the glass phase may more easily transfer lithium compared to a solid-state electrolyte including only the cubic garnet phase.

The composite solid-state electrolyte according to an embodiment may include a cubic garnet phase that is a crystal phase, and the cubic garnet phase may be included in an amount of 60 wt % or greater, 70 wt % or more, 80 wt % or greater, about 80 wt % to about 99 wt %, or about 90 wt % to about 99.5 wt % based on a total weight of the cubic garnet phase and the pyrochlore phase, and the balance is the pyrochlore phase that is a lithium-free phase. For example, the pyrochlore phase may satisfy La₂₊ₓZr₂₍₁₋ₓ₎TaₓO₇ (wherein 0≤x≤0.5). An amount of the pyrochlore phase may be about 0.5 wt % to about 40 wt %, about 0.5 wt % to about 10 wt %, about 1 wt % to about 5 wt %, or about 1 wt % to about 3 wt % based on a total amount of the cubic garnet phase and the pyrochlore phase. When the amount of the cubic garnet phase is within the ranges described above, the composite solid-state electrolyte may have a significantly high ionic conductivity. When the amount of the cubic garnet phase is within the ranges described above, a solid-state electrolyte with a high ionic conductivity may be obtained at various temperature ranges and with low interfacial resistance, combination with a positive electrode and a negative electrode may be included in manufacturing of a lithium battery.

The composite solid-state electrolyte according to an embodiment may have an ionic conductivity of 1×10⁻⁶ S/cm or greater, for example, about 1×10⁻⁶ S/cm to about 1×10⁻³ S/cm and may have a high relative density of 80% or greater, for example, about 85% to about 90% such that a dense property may be obtained without a high-temperature sintering process. In this specification, the “relative density” is a density calculated by measuring dimensions (diameter and thickness) and mass of a sintered product in comparison to a theoretical density of the composite solid-state electrolyte. Also, the relative density may be calculated by measuring density with a pychnometer in comparison to a theoretical density (e.g., a theoretical density of 5.14 grams per cubic centimeter (g/cm³) for LLZO).

The composite solid-state electrolyte according to an embodiment may be electrochemically stable at voltage of 3.0 volts (V) or greater, for example, at a voltage of about 3.0 V to about 4.5 V (vs. Li metal).

The first solid-state electrolyte may include a compound represented by Formula 2, a compound represented by Formula 3, or a combination thereof.

Liₓ(La_{y}B′_{b})(Zr_{z}C′_{c})O₁₂ Formula 2

In Formula 2, B′ may include at least one of calcium (Ca), strontium (Sr), cesium (Cs), or barium (Ba),
C′ may include at least one of aluminum (Al), tungsten (W), niobium (Nb) or tantalum (Ta),
6≤x≤8, 2≤y≤3, 0<z≤2, 0<b≤1, and 0.01≤c≤2.

(LiₓAₐ)(La_{y})(Zr_{z})O₁₂ Formula 3

In Formula 3, A may include at least one of Ga or Al, 6≤x≤8, 0≤a≤2, 2≤y≤3, and 0<z≤2.

The first solid-state electrolyte may include a compound represented by Formula 1, a compound represented by Formula 2, a compound represented by Formula 3, or combination thereof. The compounds represented by Formulas 1, 2, and 3 may be included in an amount of about 30 wt % or greater, about 40 wt % or greater, about 50 wt % or greater about 60 wt % or greater, about 70 wt % or greater, about 80 wt % or greater, about 80 wt % or greater, about 90 wt % or greater based on a total weight of the first solid-state electrolyte.

The first solid-state electrolyte may be, for example, a compound represented by Formula 4.

Li₃₊ₓLa₃Zr₂ₐC′ₐO₁₂ Formula 4

In Formula 4, C′ may include at least one of aluminum (Al), tungsten (W), niobium (Nb) or tantalum (Ta), 3≤x≤5 and 0≤a≤0.7.

According to an embodiment, the first solid-state electrolyte may be Li₇La₃Zr₂O₁₂ (LLZO), Li_{6.5}La₃Zr_{1.5}Ta_{0.5}O₁₂, Li_{6.5}La₃Zr_{1.5}Nb_{0.5}O₁₂, or Li_{6.25}La₃Zr₂Al_{0.25}O₁₂.

According to another embodiment, the first solid-state electrolyte may be LixLa₃M₂O₁₂ (wherein 6≤x≤8 and M is Ta, Nb, or Zr), LixLa₃Zr_{2-α}M_{α}O₁₂ (wherein 6≤x≤8, 0<α<2, and M is Ta or Nb,), Li_{6.24}La₃Zr₂Al_{0.24}O₁₂, Li₇La₃Zr_{1.7}W_{0.3}O₁₂, Li₇La₃Zr_{1.7}W_{0.3}O₁₂, Li_{4.9}La_{2.5}Ca_{0.5}Zr_{1.7}Nb_{0.3}O₁₂, Li_{6.4}La₃Zr_{1.7}W_{0.3}O₁₂, Li₇La₃Zr_{1.5}W_{0.5}O₁₂, Li₇La_{2.75}Ca_{0.25}Zr_{1.75}Nb_{0.25}O₁₂, Li₇La₃Zr_{1.5}Nb_{0.5}O₁₂, Li₇La₃Zr_{1.5}Ta_{0.5}O₁₂, Li₇La_{2.75}Ca_{0.25}Zr_{1.75}Nb_{0.25}O₁₂, or Li_{6.272}La₃Zr_{1.7}W_{0.3}O₁₂.

The second solid-state electrolyte may be an oxide glass lithium ion conductor. The second solid-state electrolyte may include lithium (Li), oxygen (O), and at least one of germanium (Ge), silicon (Si), boron (B), or phosphorus (P).

The oxide glass lithium ion conductor may be a glass including lithium (Li), oxygen (O), and at least one of germanium (Ge), silicon (Si), boron (B), or phosphorus (P), for example, a glass including silicon (Si), boron (B), lithium (Li), and oxygen (O). For example, the oxide glass lithium ion conductor may include a glass including Li₂O and at least one of GeO₂, SiO₂, B₂O₃, or P₂O₅, or a glass including SiO₂, B₂O₃, and Li₂O. In this regard, the glass refers to a crystallographically amorphous material as determined by X-ray diffraction or electron beam diffraction.

An amount of the Li₂O may be at about 20 mole percent (mol %) to about 75 mol %, about 25 mol % to about 75 mol %, about 30 mol % to about 75 mol %, about 40 mol % to about 75 mol %, or about 50 mol % to about 75 mol %. When the oxide glass lithium ion conductor includes SiO₂, an amount of the SiO₂ may be greater than 0 mol % to about 70 mol %, about 5 mol % to about 50 mol %, or about 10 mol % to about 30 mol %. When the oxide glass lithium ion conductor includes B₂O₃, an amount of the B₂O₃ may be greater than 0 mol % to about 60 mol %, about 5 mol % to about 80 mol %, about 10 mol % to about 60 mol %, or about 20 mol % to about 50 mol %. In addition, the amounts of the respective oxides are amounts of the oxides contained in the oxide glass lithium ion conductor and, for example, a percentage of moles (mol %) of each oxide based on the total moles of oxide in the oxide glass. For example, the total moles of oxide in the oxide glass include the moles of Li₂O and the moles of at least one of SiO₂, B₂O₃, or P₂O₅. The amounts of the oxides may be measured by inductively coupled plasma atomic emission spectroscopy (ICP-AES), or the like.

The oxide glass lithium ion conductor may further include an additive, if required. The additive may include, for example, at least one of sodium (Na), magnesium (Mg), aluminum (Al), potassium (K), calcium (Ca), titanium (Ti), vanadium (V), chromium (Cr), manganese (Mn), iron (Fe), cobalt (Co), nickel (Ni), copper (Cu), zinc (Zn), gallium (Ga), selenium (Se), rubidium (Rb), sulfur(S), yttrium (Y), zirconium (Zr), niobium (Nb), molybdenum (Mo), silver (Ag), indium (In), tin (Sn), antimony (Sb), cesium (Cs), barium (Ba), hafnium (Hf), tantalum (Ta), tungsten (W), lead (Pb), bismuth (Bi), gold (Au), lanthanum (La), neodymium (Nd), or europium (Eu). The oxide glass lithium ion conductor may include at least one of the additives as an oxide.

### Method of Preparing Composite Solid-State Electrolyte

A method of preparing a composite solid-state electrolyte according to an embodiment includes: mixing a first solid-state electrolyte precursor including an amorphous phase and a second solid-state electrolyte precursor including a glass phase to prepare a composite solid-state electrolyte-forming composition; and heat-treating the composite solid-state electrolyte-forming composition to prepare the composite solid-state electrolyte.

The heat treatment may be performed in a temperature greater than the crystallization temperature of the first solid-state electrolyte and less than the crystallization temperature of the second solid-state electrolyte. For example, the heat treatment of the composite solid-state electrolyte-forming composition may be performed at a temperature of 550° C. or less, for example, about 350° C. to about 550° C., about 400° C. to about 500° C., about 410° C. to about 480° C., or about 420° C. to about 470° C.

In the heat treatment process, the amorphous first solid-state electrolyte precursor is crystallized to form the first solid-state electrolyte having the cubic garnet phase and the pyrochlore phase, and the glass-phase second solid-state electrolyte may connect particles of the first solid-state electrolyte while being maintained in the glass phase. In addition, the composite solid-state electrolyte according to an embodiment further includes crystalline particles of the first solid-state electrolyte formed during the preparation process, so as to include smaller particles than a commercially available crystalline first solid-state electrolyte. While the amorphous first solid-state electrolyte precursor is crystallized, an interface close to the second solid-state electrolyte may be formed. The composite solid-state electrolyte according to an embodiment may have increased conductivity and density.

After the heat treatment, the composite solid-state electrolyte may include the first solid-state electrolyte including a cubic garnet phase and a pyrochlore phase. The cubic garnet phase may be derived from the amorphous first solid-state electrolyte precursor. The pyrochlore phase may be derived from the amorphous first solid-state electrolyte precursor or from a reaction between the amorphous first solid-state electrolyte precursor and the glass-phase second solid-state electrolyte precursor.

The amorphous first solid-state electrolyte precursor may be used as a starting material of the first solid-state electrolyte including the cubic garnet phase and the pyrochlore phase. Therefore, types and amounts of the elements of the first solid-state electrolyte precursor may be substantially identical to or similar to types and amounts of the first solid-state electrolyte including the cubic garnet phase and the pyrochlore phase. For example, the amorphous first solid-state electrolyte precursor may include a compound represented by Formula 1.

(LiₓAₐ)(La_{y}B′_{b})(Zr_{z}C′_{c})O₁₂ Formula 1

In Formula 1,
A may be a monovalent, divalent, or trivalent cation, or a combination thereof,
B′ may be a monovalent, divalent, or trivalent cation, or a combination thereof,
C′ may be a monovalent, divalent, trivalent, tetravalent, pentavalent, or hexavalent cation, or a combination thereof,
6≤x≤8, 0≤a≤2, 2≤y≤3, 0≤b≤1, 0<z≤2, and 0≤c≤2.

The amorphous first solid-state electrolyte precursor may include the compounds of Formulae 2 and 3 described in the first solid-state electrolyte, or a combination thereof. In addition, the amorphous first solid-state electrolyte precursor may include the compound represented by Formula 4 described in the first solid-state electrolyte.

The composite solid-state electrolyte-forming composition may further include the C′-containing precursor of Formula 1, and the C′-containing precursor may include at least one of a tantalum precursor, an aluminum precursor, a tungsten precursor, or a niobium precursor.

The amorphous first solid-state electrolyte precursor may be prepared by mechanochemically synthesizing precursors for forming the first solid-state electrolyte.

For example, the amorphous first solid-state electrolyte precursor may be prepared by mixing a lithium precursor, a lanthanum precursor, a zirconium precursor, and the C′-containing precursor to prepare the precursors for forming the first solid-state electrolyte, and mechanochemically synthesizing with the precursors for forming the first solid-state electrolyte. Alternatively, the amorphous first solid-state electrolyte precursor may be prepared by obtaining a pyrochlore phase-containing precursor by heat-treating a mixture of a lanthanum precursor, a zirconium precursor, and a C′-containing precursor, mixing the pyrochlore phase-containing precursor with a lithium precursor, and mechanochemically synthesizing with the mixture.

The pyrochlore phase-containing precursor may be, for example, a compound represented by Formula 5.

(La_{y}B′_{b})(Zr_{z}C′_{c})O₇ Formula 5

In Formula 5, B′ may be a monovalent, divalent, or trivalent cation, or a combination thereof,
C′ may be a monovalent, divalent, trivalent, tetravalent, pentavalent, or hexavalent cation, or a combination thereof,
2≤y≤3, 0≤b≤1, 0<z≤2, and 0≤c≤2.

The pyrochlore phase-containing precursor may be, for example, La_{2.4}Zr_{1.2}Ta_{0.4}O₇.

The lanthanum precursor may include an oxide, a sulfate, a chloride, or a combination thereof containing lanthanum. The zirconium precursor may include an oxide, a sulfate, a chloride, or a combination thereof containing zirconium. The C′ element precursor may include an oxide, a sulfate, a chloride, or a combination thereof containing a C′ element. The lithium precursor may include an oxide, a sulfate, a chloride, or a combination thereof containing lithium.

The lanthanum precursor may be, for example, La₂O₃, LaCl₃, or the like, and the zirconium precursor may be, for example, ZrO₂, ZrCl₂, or the like. In addition, the tantalum precursor may be, for example, Ta₂O₅, TaCl₅, or the like.

The lithium precursor may be, for example, Li₂O, LiCl, LiOH, Li₂ (CO₃), or the like. The lanthanum precursor, the zirconium precursor, the C′-containing precursor, and the lithium precursor may be used in stoichiometric amounts corresponding to the composition of the amorphous first solid-state electrolyte. For example, the amount of the lithium precursor may be about 2.6 moles (mol) to about 5.2 mol based on 1 mol of the pyrochlore phase-containing precursor.

In the preparation of the pyrochlore phase-containing precursor, the mixture of the lanthanum precursor, the zirconium precursor, and the C′-containing precursor may be heat-treated at a temperature of about 1000° C. to about 1500° C., about 1100° C. to about 1400° C., or about 1200° C. to about 1350° C. under atmospheric conditions or in an oxygen atmosphere.

The heat treatment of the mixture may be a solid-phase reaction and may be performed, for example, for about 5 hours to about 50 hours or about 10 hours to about 50 hours.

The mechanochemically synthesizing may include mechanical milling.

The mechanical milling may include, for example, high-energy mechanical milling (HEMM).

The high-energy mechanical milling refers to a process of combining components by applying a mechanical energy thereto.

The high-energy mechanical milling may not only atomize powder by applying a high energy to reactants via high rotational force, but also induce chemical reaction in the reactants by a maximized diffusing force between particles of powder. In addition, the high-energy mechanical milling may be achieved using a Mechanofusion device, a Nobilta device, or the like. Mechanofusion, as a method of preparing a mixture by a strong physical rotational force in a dry state, is a method of forming an electrostatic binding force among the components. Through this process, powder with fine particles having uniform distribution properties may be obtained. The particles may have an average particle diameter of about 1 nm to about 100 μm or about 5 nm to about 80 μm.

The high-energy mechanical milling may be, for example, high-energy ball milling, and the high-energy ball milling may be performed by any ball mills used for high-energy ball milling such as vibratory-mill, Z-mill, planetary ball-mill, attrition-mill, SPEX mill, low-temperature grinder, friction mill, shaker mill, stirring ball mill, mixer ball mill, and vertical and horizontal attritor.

Any commercially available high-energy mechanical milling devices may be used therefor. For example, the ball mills may be, but are not limited to, SPEX CertiPrep Group L.L.C. (8000 M Mixer/Mill®), Zoz GmbH (Simoloyer®), Retsch GmbH (Planetary Ball Mill PM 200/400/400 MA), and Union Process Inc. (Attritor®).

For example, Pulverisette 7 Premium line device may be used. While undergoing such a high-energy milling, the size of the first solid-state electrolyte having the garnet-type crystal structure may be reduced to facilitate the reaction therebetween, so that the composite solid-state electrolyte may be prepared within a short period of time.

Pulverizing balls used in the high-energy ball milling may be stainless steel beads or zirconia beads (ZrO₂), but are not limited thereto, and may be any of those with a particle size of about 0.5 millimeters (mm) to about 20 mm. A pulverization time of the high-energy mechanical milling may be about 0.5 hours to about 150 hours.

The high-energy mechanical milling may be performed by a dry method in an inert atmosphere for about 0.5 hours to about 1000 hours, about 0.5 hours to about 100 hours, or about 10 hours to about 30 hours. The high-energy mechanical milling may be performed, for example, by a dry method in an inert atmosphere at a rate of about 300 revolutions per minute (rpm) to about 10000 rpm, about 350 rpm to about 5000 rpm, or about 370 rpm to about 1000 rpm. The high-energy mechanical milling may be performed for about 0.5 hours to about 150 hours. During the high-energy ball milling process, the temperature may be raised to 200° C., the pressure may also be, for example, 6 gigapascals (GPa).

By the high-energy mechanical milling, the particle size may have a sub-micro level of 1 μm or less, for example, about 10 nm to about 1 μm, about 20 nm to about 900 nm, or about 30 nm to about 500 nm.

The high-energy mechanical milling may be performed in an inert atmosphere, and the inert atmosphere may be an atmosphere from which oxygen is substantially excluded. The inert atmosphere may be, for example, an atmosphere including nitrogen, argon, neon, or a combination thereof. The mechanochemical reaction may be, for example, an exothermic reaction. The reaction forming the solid-state electrolyte may be an exothermic reaction. A temperature of the exothermic reaction may be, for example, about 100° C. to about 500° C., about 100° C. to about 400° C., about 100° C. to about 300° C., or about 100° C. to about 200° C. The mechanical milling may be performed, for example, by a dry method without using a solvent or the like. By performing the mechanical milling by the dry method, a post process step such as a process of removing a solvent may be omitted.

Before heat-treating the mixture of the composite solid-state electrolyte-forming composition including the amorphous first solid-state electrolyte precursor and the glass-phase second solid-state electrolyte precursor, mechanical milling may further be performed. The mechanical milling may include high-energy mechanical milling. The mechanical milling is as described above.

If required, an organic solvent may further be added during the high-energy mechanical milling. By performing bead mill pulverization in an organic solvent, dissolution of lithium may be prevented by pulverized products, and fine pulverized products may be obtained with a uniform composition.

The organic solvent may include at least one of an alcohol-based solvent, a ketone-based solvent, an ester-based solvent, a glycol ether-based solvent, a hydrocarbon-based solvent, an ether-based solvent, a glycol-based solvent, or an amine-based solvent. For example, the organic solvent may include at least one of an alcohol-based solvent such as isopropyl alcohol, toluene, methanol, ethanol, butanol, hexanol, benzyl alcohol, and isopropyl alcohol, a ketone-based solvent such as acetone, methylethyl ketone, methyl isobutylketone, and cyclohexanone, an ester-based solvent such as methyl acetate, ethyl acetate, and butyl acetate, an ether-based solvent such as propyleneglycol monomethylether, ethyleneglycol monoethylether, ethylglycol monobutylether, 3-methoxy-3 methyl-1-butanol, and diethyleneglycol monobutylether, a hydrocarbon-based solvent such as benzene, toluene, xylene, cyclohexane, methylcyclohexane, ethylcyclohexane, mineral oil, n-paraffin, and iso-paraffin, an ether-based solvent such as 1,3-dioxolane, 1,4-dioxolane, and tetrahydrofuran, a glycol-based solvent such as ethyleneglycol, diethyleneglycol, propyleneglycol, and polyethyleneglycol, or an amine-based solvent such as monoethanolamine, diethylamine, triethanolamine, n-methyl-2-pyrrolidone, 2-amino-2-methyl-1-propanol, and N,N-dimethylformamide. When water having strong hydrophilicity is used as a solvent, lithium (Li) may be dissolved, so that the crystalline structure of LLZO may break down. However, because the above-described organic solvent has strong hydrophobicity, Li is substantially undissolved therein, so that the crystalline structure of LLZO may be easily maintained. In addition, by using toluene as the organic solvent, generation of impurities may further be inhibited.

### Lithium Battery

A lithium battery according to another embodiment includes a positive electrode, a negative electrode, and an electrolyte layer disposed between the positive electrode and the negative electrode, wherein at least one of the positive electrode, the negative electrode, or the electrolyte may include the composite solid-state electrolyte according to an embodiment. When the lithium battery includes the above-described composite solid-state electrolyte, internal resistance of the lithium battery may be reduced and cycle characteristics of the lithium battery may be improved. The lithium battery is not particularly limited, but may be, for example, a lithium-ion battery, an all-solid secondary battery, or a lithium air battery. The all-solid secondary battery may be, for example, a multilayer ceramic capacitor (MLC).

According to an embodiment, the positive electrode may include, for example, the composite solid-state electrolyte according to an embodiment. In addition, when the lithium battery is prepared by using the composite solid-state electrolyte according to an embodiment, very uniform interfacial properties may be obtained between the solid-state electrolyte and the positive electrode.

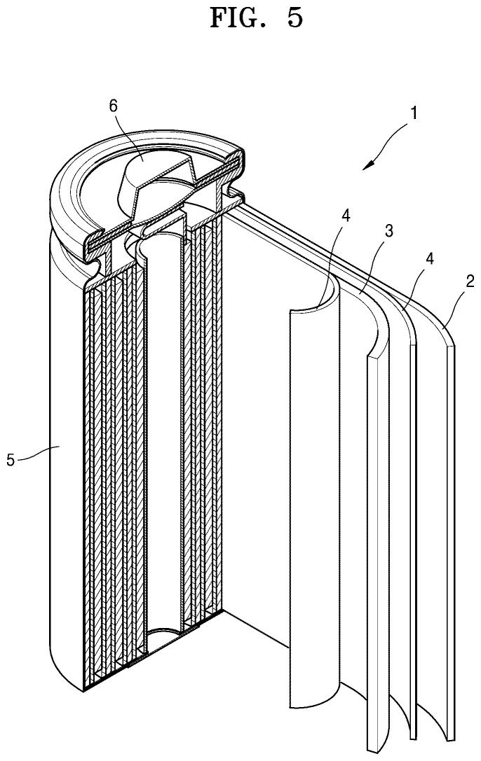

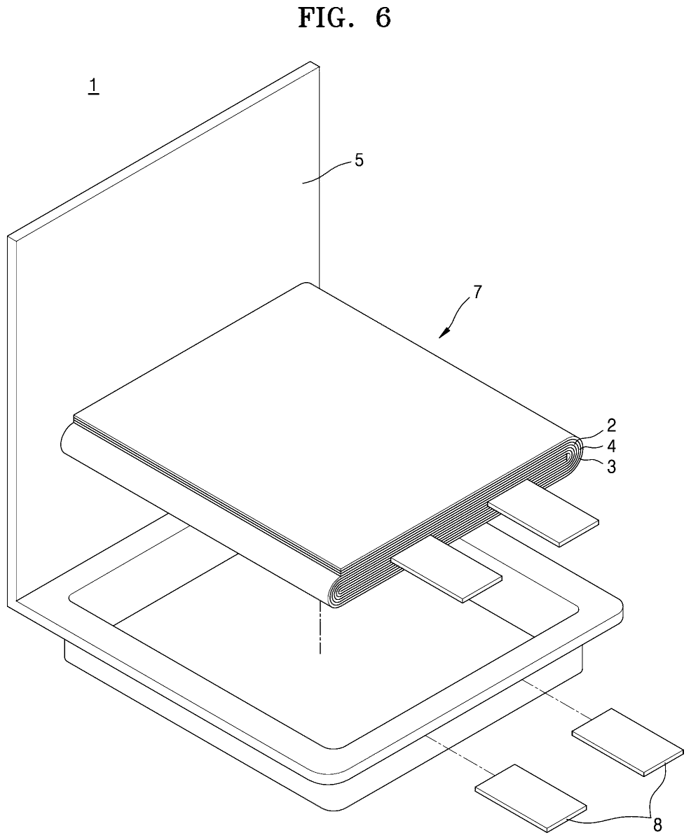

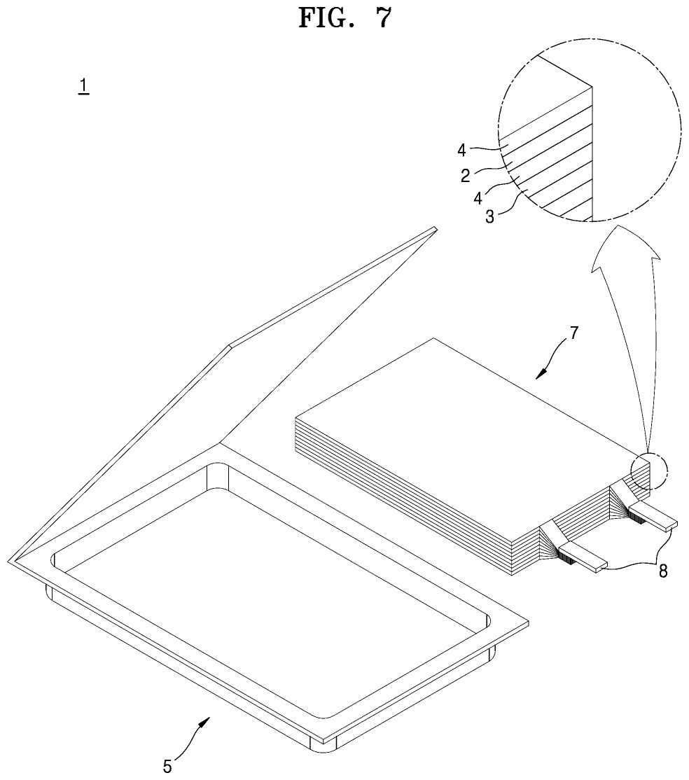

FIG. 5 illustrates a cylindrical “jelly roll” structure for a lithium battery 1. The battery 1 may include an anode 2, an electrolyte (e.g., separator) 4, and a cathode 3 within a case 5. The positive terminal 6 is also shown. In FIG. 6, a jelly roll pouch cell structure for a lithium battery 1 is shown with a pouch 7 and tabs 8. FIG. 7 illustrates a stacked pouch cell structure for a battery 1.

Hereinafter, these batteries will be described in more detail.

### Lithium-Ion Battery

The lithium-ion battery may be, for example, a lithium battery including a liquid electrolyte. The lithium-ion battery may include the composite solid-state electrolyte according to an embodiment.

The lithium-ion battery may include, for example, a positive electrode including a positive active material; a negative electrode including a negative active material; and a liquid electrolyte disposed between the positive electrode and the negative electrode, wherein at least one of the positive electrode and the negative electrode may include the composite solid-state electrolyte according to an embodiment. The lithium-ion battery may include, for example, a positive electrode, a negative electrode, and a liquid electrolyte disposed between the positive electrode and the negative electrode, wherein a protective layer including the composite solid-state electrolyte according to an embodiment may be disposed on one side of at least one of the positive electrode and the negative electrode. The lithium-ion battery may include, for example, a positive active material layer, wherein the positive active material layer may include a composite positive active material including a core including a positive active material and a first coating layer disposed on the core, wherein the first coating layer may include the composite solid-state electrolyte according to an embodiment. The lithium-ion battery may include, for example, a negative active material layer, wherein the negative active material layer may include a composite negative active material including a core including a negative active material and a second coating layer disposed on the core, wherein the second coating layer may include the composite solid-state electrolyte according to an embodiment.

### All-Solid Secondary Battery

The all-solid secondary battery may include the composite solid-state electrolyte according to an embodiment.

The all-solid secondary battery may include: a positive electrode; a negative electrode; and a sold electrolyte layer disposed between the positive electrode and the negative electrode, wherein at least one of the positive electrode, the negative electrode, or the solid electrolyte layer may include the composite solid-state electrolyte according to an embodiment.

First Type: Non-Plated Negative Electrode-Containing all-Solid Secondary Battery

FIG. 5 is a schematic diagram of an all-solid secondary battery including a non-plated negative electrode according to an embodiment. In an all-solid secondary battery including a non-plated negative electrode, an initial charging capacity of a negative active material layer during initial charging may be, for example, 50% or greater, 60% or greater, 70% or greater, 80% or greater, 90% or greater, or 100% or greater of an initial charging capacity of a positive active material layer.

The all-solid secondary battery may be prepared as follows.

First, a solid electrolyte layer may be prepared. The solid electrolyte layer may include the composite solid-state electrolyte according to an embodiment. The solid electrolyte layer may be prepared, for example, by applying the composite solid-state electrolyte-forming composition and drying the composition, or by preparing the composite solid-state electrolyte-forming composition in a powder form and pressing the powder.

The composite solid-state electrolyte-forming composition may include a binder. The binder may be, for example, styrene butadiene rubber (SBR), polytetrafluoroethylene, polyvinylidene fluoride, polyethylene, or polyvinyl alcohol, but is not limited thereto, and may be any binders commonly available in the art. The binder of the solid electrolyte layer may be identical to or different from binders of the positive electrode and the negative electrode.

The solid electrolyte layer may further include an oxide solid electrolyte, a sulfide solid-state electrolyte, or a combination thereof in addition to the composite solid-state electrolyte according to an embodiment.

Subsequently, a positive electrode is prepared.

The positive electrode may be prepared by forming a positive active material layer including a positive active material on a positive current collector. The positive active material layer may be prepared by a vapor phase method or a solid phase method. The vapor phase method may be pulsed laser deposition (PLD), sputtering deposition, chemical vapor deposition, or the like, but is not limited thereto, and may be any method commonly used in the art. The solid phase method may be sintering, a sol-gel method, a doctor blade method, screen printing, slurry casting, powder compression, or the like, but is not limited thereto, and may be any method commonly used in the art.

As the positive active material, a compound allowing reversible intercalation and deintercalation of lithium (a lithiated intercalation compound) may be used. For example, one or more types of composite oxides of lithium and a metal may be cobalt, manganese, nickel, or a combination thereof may be used. The composite oxide may be a lithium transition metal composite oxide, and examples thereof may be a lithium nickel oxide, a lithium cobalt oxide, a lithium manganese oxide, a lithium iron phosphate compound, a cobalt-free nickel manganese oxide, or a combination thereof. Examples of the composite oxides may include one of the compounds represented by the following formulae. LiₐA_{1-b}X_{b}O_{2-c}D′_{c} (wherein 0.90≤a≤1.8, 0≤b≤0.5, and 0≤c≤0.05); LiₐMn_{2-b}X_{b}O_{4-c}D′_{c} (wherein 0.90≤a≤1.8, 0≤b≤0.5, and 0≤c≤0.05); LiₐNi_{1-b-c}CO_{b}X_{c}O₂₋ₐD′ₐ (wherein 0.90≤a≤1.8, 0≤b≤0.5, 0≤c≤0.5, and 0<α<2); LiₐNi_{1-b-c}Mn_{b}X_{c}O₂₋ₐD′ₐ (wherein 0.90≤a≤1.8, 0≤b≤0.5, 0≤c≤0.5, and 0<α<2); LiₐNi_{b}Co_{c}L¹_{d}GₑO₂ (wherein 0.90≤a≤1.8, 0≤b≤0.9, 0≤c≤0.5, 0≤d≤0.5, and 0≤e≤0.1); LiₐNiG_{b}O₂ (wherein 0.90≤a≤1.8 and 0.001≤b≤0.1); LiₐCoG_{b}O₂ (wherein 0.90≤a≤1.8 and 0.001≤b≤0.1); LiₐMn_{1-b}G_{b}O₂ (wherein 0.90≤a≤1.8 and 0.001≤b≤0.1); LiₐMn₂G_{b}O₄ (wherein 0.90≤a≤1.8 and 0.001≤b≤0.1); LiₐMn_{1-g}G_{g}PO₄ (wherein 0.90≤a≤1.8 and 0≤g≤0.5); Li_{(3-f)}Fe₂(PO₄)₃ (wherein 0≤f≤2); and LiₐFePO₄ (wherein 0.90≤a≤1.8). In the formulae, A may be Ni, Co, Mn, or a combination thereof; X may be Al, Ni, Co, Mn, Cr, Fe, Mg, Sr, V, a rear earth element, or a combination thereof; D′ may be O, F, S, P, or a combination thereof; G may be Al, Cr, Mn, Fe, Mg, La, Ce, Sr, V, or a combination thereof; and L¹ may be Mn, Al or a combination thereof.

The positive active material layer may further include a binder, a conductive material, and the like. Examples of the binder may include polyvinyl alcohol, carboxymethyl cellulose, hydroxypropyl cellulose, diacetylcellulose, polyvinylchloride, carboxylated polyvinylchloride, polyvinylfluoride, ethylene oxide-containing polymer, polyvinylpyrrolidone, polyurethane, polytetrafluoroethylene, polyvinylidene fluoride, polyethylene, polypropylene, styrene-butadiene rubber, (meth)acrylate styrene-butadiene rubber, epoxy resin, (meth)acrylic resin, polyester resin, and nylon, but are not limited thereto. Examples of the conductive material may include: a carbonaceous material such as natural graphite, artificial graphite, carbon black, acetylene black, Ketjen black, carbon fiber, carbon nanofiber, and carbon nanotube; a metallic material including copper, nickel, aluminum, and silver in powder or fiber form; a conductive polymer such as a polyphenylene derivative; or a mixture thereof.

Al may be used as the positive current collector, without being limited thereto.

Subsequently, a negative electrode is prepared. The negative electrode may be prepared in the same manner as the positive electrode, except that a negative active material is used instead of the positive active material. The negative electrode may be prepared by forming a negative active material layer including a negative active material on a current collector.

The negative active material may include a material allowing reversible intercalation/deintercalation of lithium ions, lithium metal, an alloy of lithium metal, a material allowing doping and undoping of lithium, or a transition metal oxide.

The material allowing reversible intercalation/deintercalation of lithium ions may be a carbonaceous negative active material such as crystalline carbon, amorphous carbon, or a combination thereof. Examples of the crystalline carbon may be graphite such as natural graphite or artificial graphite in non-shaped, plate-like, flake, spherical, or fibrous form, and examples of the amorphous carbon may be soft carbon or hard carbon, mesophase pitch carbide, or calcined coke.

The alloy of lithium metal may be an alloy of lithium with a metal. The metal may at least one of Na, K, Rb, Cs, Fr, Be, Mg, Ca, Sr, Si, Sb, Pb, In, Zn, Ba, Ra, Ge, Al, or Sn.

The material allowing doping and undoping of lithium may be a Si-containing negative active material or a Sn-containing negative active material. The Si-containing negative active material may be silicon, a Si—C composite, SiOx (wherein 0<x<2), a Si-Q alloy (wherein Q is an alkali metal, an alkali earth metal, a Group 13 element, a Group 14 element (except for Si), a Group 15 element, a Group 16 element, a transition metal, a rear earth element, and a combination thereof), or a combination thereof. The Sn-containing negative active material may be Sn, SnO₂, a Sn alloy, or a combination thereof.

The negative active material layer may further include a binder, a conductive material, and the like. The binder and the conductive material may be selected from the above-described materials used in positive active material layer.

Referring to FIG. 5, the all-solid secondary battery 40 includes a solid electrolyte layer 30, a positive electrode 10 disposed on one side of the solid electrolyte layer 30, and a negative electrode 20 disposed on the other side of the solid electrolyte layer 30. The positive electrode 10 may include a positive active material layer 12 in contact with the solid electrolyte layer 30 and a positive current collector 11 in contact with the positive active material layer 12. The negative electrode 20 may include a negative active material layer 22 in contact with the solid electrolyte layer 30 and a negative current collector 21 in contact with the negative active material layer 22. For example, the all-solid secondary battery 40 may be prepared, for example, by disposing the positive active material layer 12 and the negative active material layer 22 on both sides of the solid electrolyte layer 30 and disposing the positive current collector 11 and the negative current collector 21 on the positive active material layer 12 and the negative active material layer 22, respectively. Alternatively, the all-solid secondary battery 40 may be prepared by sequentially stacking the negative active material layer 22, the solid electrolyte layer 30, the positive active material layer 12, and the positive current collector 11 on the negative current collector 21.

Second Type: Plated Negative Electrode-Containing all-Solid Secondary Battery

FIGS. 6 and 7 are schematic diagrams of an all-solid secondary battery including a plated negative electrode according to an embodiment. An all-solid secondary battery 40 may include, for example, a positive electrode 10 including a positive current collector 11 and a positive active material layer 12 disposed on the positive current collector 11; a negative electrode 20 including a negative current collector 21 and a negative active material layer 22 disposed on the negative current collector 21; and an electrolyte layer 30 disposed between the positive electrode 10 and the negative electrode 20, wherein the positive active material layer 12 and/or the solid electrolyte layer 30 may include the composite solid-state electrolyte according to an embodiment.

Referring to FIGS. 6 and 7, the negative electrode 20 may include the negative current collector 21 and the negative active material layer 22 disposed on the negative current collector 21, and the negative active material layer 22 may include, for example, a negative active material and a binder.

The negative active material included in the negative active material layer 22 may be, for example, in the form of particles. The negative active material in the form of particles may have an average particle diameter of, for example, 4 μm or less, about 10 nm to about 4 μm, about 10 nm to about 3 μm, about 10 nm to about 2 μm, about 10 nm to about 1 μm, or about 10 nm to about 900 nm. If the average particle diameter of the negative active material is within the ranges described above, reversible absorbing and/or desorbing of lithium may occur more easily during charging and discharging. The average particle diameter of the negative active material may be, for example, a median diameter D50 measured using a laser particle size analyzer.

The negative active material included in the negative active material layer 22 may include, for example, at least one of a carbonaceous negative active material, a metal negative active material, or a metalloid negative active material.

The carbonaceous negative active material may be, for example, amorphous carbon, and the amorphous carbon may be, for example, carbon black, acetylene black, furnace black (FB), ketjen black (KB), and graphene, but is not limited thereto, and may be any materials classified as amorphous carbon in the art.

The metal or metalloid negative active material may include at least one of gold (Au), platinum (Pt), palladium (Pd), silicon (Si), silver (Ag), aluminum (Al), bismuth (Bi), tin (Sn), or zinc (Zn). The negative active material included in the negative active material layer 22 may include, for example, a mixture of first particles formed of amorphous carbon and second particles formed of a metal or metalloid. An amount of the second particles may be about 8 weight percent (wt %) to about 60 wt %, about 10 wt % to about 50 wt %, about 15 wt % to about 40 wt %, or about 20 wt % to about 30 wt % based on a total weight of the mixture. When the amount of the second particles is within the ranges above, cycle characteristics of the all-solid secondary battery 40 may further be improved.

The binder included in the negative active material layer 22 may be, for example, styrene butadiene rubber (SBR), polytetrafluoroethylene, polyvinylidene fluoride, polyvinylidene fluoride/hexafluoropropylene copolymer, polyethyleneoxide polyacrylonitrile, polymethylmethacrylate, carboxymethylcellulose, hydroxypropylmethyl cellulose, methyl cellulose, or alkali metal salts thereof, but is not limited thereto, and may be any materials commonly used in the art as a binder. The negative active material layer 22 may be stabilized on the negative current collector 21, because the negative active material layer 22 includes the binder. Also, cracks may be inhibited in the negative active material layer 22, although a volume and/or a relative position of the negative active material layer 22 changes during a charging and discharging process.

Referring to FIG. 7, an all-solid secondary battery 40a may further include, for example, a metal layer 23 disposed between the negative current collector 21 and the negative active material layer 22. The metal layer 23 may be metal foil or a plated metal layer. The metal layer 23 may include lithium or a lithium alloy. Therefore, the metal layer 23 may serve, for example, as a lithium reservoir. The lithium alloy may be, for example, Li—Al alloy, Li—Sn alloy, Li—In alloy, Li—Ag alloy, Li—Au alloy, Li—Zn alloy, Li—Ge alloy, or Li—Si alloy. The metal layer 23 may have a thickness of, for example, about 1 μm to about 200 μm, about 1 μm to about 100 μm, about 1 μm to about 70 μm, about 1 μm to about 50 μm, about 1 μm to about 30 μm, or 1 μm to about 20 μm. When the thickness of the metal layer 23 is within the ranges above, the all-solid secondary battery 40a may have improved cycle characteristics.

In the all-solid secondary battery 40a, the metal layer 23 may be disposed between the negative current collector 21 and the negative active material layer 22 before assembling the all-solid secondary battery 40a or may be plated between the negative current collector 21 and the negative active material layer 22 by charging after assembling the all-solid secondary battery 40a. In the case where the metal layer 23 is disposed between the negative current collector 21 and the negative active material layer 22 before assembling the all-solid secondary battery 40a, the metal layer 23 that is a metal layer including lithium may serve as a lithium reservoir. In the case where the metal layer 23 is plated by charging after assembling the all-solid secondary battery 40a, energy density of the all-solid secondary battery 40a may increase because the metal layer 23 is not included while the all-solid secondary battery 40a is assembled. In addition, in the case of disposing the metal layer 23 by charging after assembling the all-solid secondary battery 40a, a region between the negative current collector 21 and the negative active material layer 22 may be a Li-free region not including lithium (Li) in the early stage of charging or after discharging the all-solid secondary battery 40a.

The negative current collector 21 may be formed of, for example, a material that does not react with lithium, i.e., a material that does not form an alloy and compound with lithium. The material constituting the negative current collector 21 may be, for example, copper (Cu), stainless steel, titanium (Ti), iron (Fe), cobalt (Co), or nickel (Ni), but is not limited thereto, and may be any materials commonly available in the art as electrode current collectors. The negative current collector 21 may be formed of one metal selected from those described above or an alloy or coating material of two or more metals selected therefrom.

The all-solid lithium battery may further include, for example, a thin film including elements capable of forming an alloy with lithium on the negative current collector 21. The thin film may be disposed between the negative current collector 21 and the negative active material layer 22. The thin film may include, for example, an element alloyable with lithium and may be, for example, gold (Au), silver (Ag), zinc (Zn), tin (Sn), indium (In), silicon (Si), aluminum (Al), or bismuth (Bi). The thin film may be formed of any one of the metals or an alloy of various types of metals. By disposing the thin film on the negative current collector 21, the metal layer 23 plated between the thin film and the negative active material layer 22 may become flatter, thereby further improving cycle characteristics of the sodium all-solid secondary batteries 40 and 40a.

For example, the thin film may have a thickness of about 1 nm to about 800 nm, about 10 nm to about 700 nm, about 50 nm to about 600 nm, or about 100 nm to about 500 nm. When the thickness of the thin film is within the ranges, an all-solid secondary battery having improved cycle characteristics may be prepared. The thin film may be disposed on the negative current collector 21, for example, by vacuum deposition, sputtering, plating, or the like.

### Multilayer Ceramic Capacitor (MLC)

The multilayer ceramic capacitor may include, for example, a plurality of positive electrodes; a plurality of negative electrodes alternately located between the plurality of positive electrodes; and solid electrolyte layers alternately disposed between the plurality of positive electrodes and the plurality of negative electrodes. The solid electrolyte layer may include the composite solid-state electrolyte according to an embodiment.

The multilayer ceramic capacitor may be, for example, a sintered product of a stack structure in which a positive active material composition, a negative active material composition, and a composite solid-state electrolyte precursor are sequentially stacked. The multilayer ceramic capacitor may be a stack structure in which a positive active material, a negative active material, and a composite solid-state electrolyte are sequentially stacked, or a sintered product of the stack structure.

The positive active material composition may include a positive active material and a binder. The positive active material composition may further include a conductive material. As the binder and the conductive material, the binders and the conductive materials described above in the positive electrode of the all-solid secondary battery may be used.

The positive active material composition may include a precursor for forming the composite solid-state electrolyte according to an embodiment. The composite solid-state electrolyte precursor may be converted into the composite solid-state electrolyte during a co-sintering process of the stack structure which will be described below.

The multilayer ceramic capacitor may have a stack structure in which a plurality of unit cells, in each of which a positive electrode including a positive active material layer; a solid electrolyte layer; and a negative electrode including a negative active material layer, are consecutively sequentially stacked, are stacked such that the positive active material layer faces the negative active material layer. The multilayer ceramic capacitor may further include, for example, a positive current collector and/or a negative current collector. In the case where the multilayer ceramic capacitor includes a positive current collector, the positive active material layer may be disposed on both sides of the positive current collector. In the case where the multilayer ceramic capacitor includes a negative current collector, the negative active material layer may be disposed on both sides of the negative current collector. In the case where the multilayer ceramic capacitor further includes the positive current collector and/or the negative current collector, high-rate characteristics of the multilayer ceramic capacitor may further be improved. In the multilayer ceramic capacitor, unit cells may be stacked by disposing the current collector layer one of or both of the uppermost layer and the lowermost layer or by interposing the metal layer in the stack structure. The multilayer ceramic capacitor or thin film battery may be, for example, a small-sized or ultrasmall-sized battery applicable as a power source of Internal of Things (IoT) application, wearable devices, and the like. The multilayer ceramic capacitor or the thin film battery may also be applied to, for example, middle- and large-sized batteries such as electric vehicles (EVs) and energy storage systems (ESSs).

The negative electrode included in the multilayer ceramic capacitor may include, for example, at least one negative active material of a lithium metal phosphate, a lithium metal oxide, a metal oxide, or a carbonaceous negative active material.

The carbonaceous negative active material may include, for example, amorphous carbon, crystalline carbon, porous carbon, or a combination thereof. The crystalline carbon may be, for example, graphite such as natural graphite or artificial graphite in amorphous, plate-like, flake, spherical or fibrous form.

The amorphous carbon may include, for example, carbon black (CB), acetylene black (AB), furnace black (FB), Ketjen black (KB), graphene, soft carbon, hard carbon, mesophase pitch carbide, calcined coke, or the like. Amorphous carbon may be carbon that does not have crystallinity or has very low crystallinity and may be distinguished from crystalline carbon.

The carbonaceous negative active material may be, for example, porous carbon. A volume of pores in the porous carbon may be, for example, about 0.1 cubic centimeter per gram (cc/g) to about 10.0 cc/g, about 0.5 cc/g to about 5 cc/g, or about 0.1 cc/g to about 1 cc/g. The porous carbon may have an average pore diameter of, for example, about 1 nm to about 50 nm, about 1 nm to about 30 nm, or about 1 nm to about 10 nm. The porous carbon may have a Brunauer-Emmett-Teller (BET) specific surface area of, for example, about 100 square meters per gram (m²/g) to about 3000 m²/g.

The negative active material may be, for example, a compound Li_{4/3}Ti_{5/3}O₄, LiTiO₂, LiM1ₛM2ₜOᵤ (wherein M1 and M2 are transition metals and s, t, and u are positive numbers), TiOₓ (wherein 0<x≤3), or LiₓV₂(PO₄)₃ (wherein 0<x≤5). The negative active material according to an embodiment may be Li_{4/3}Ti_{5/3}O₄, LiTiO₂, or a combination thereof.

The positive electrode included in the multilayer ceramic capacitor may include a positive active material. The positive active material may be selected from any positive active materials used in secondary batteries such as all-solid secondary batteries. The positive active material may include at least one of a lithium metal phosphate or a lithium metal oxide, for example, lithium cobalt oxide, lithium iron phosphate, lithium nickel cobalt manganese oxide, lithium nickel cobalt aluminum oxide, lithium nickel cobalt manganese aluminum oxide, or a combination thereof.

The current collector layer may be any current collector serving as the positive current collector and/or the negative current collector. The current collector layer may be formed of, for example, a metal including Ni, Cu, Ag, Pd, Au, or Pt. The current collector layer may be formed of, for example, an alloy including Ni, Cu, Ag, Pd, Au, or Pt. The alloy may be, for example, an alloy of two or more of Ni, Cu, Ag, Pd, Au, or Pt. The alloy may be, for example, an Ag/Pd alloy. The metal and alloy may be used alone or in a mixture of at least two thereof. The material of the current collector layer as the positive current collector may be identical to or different from the material of the current collector layer as the negative current collector. The alloy or powder mixture of Ag and Pd may have a melting point that is adjustable consecutively and arbitrarily from a melting point of silver (962° C.) to a melting point of palladium (1550° C.) by a mixing ratio thereof at a sintering temperature, and may inhibit an increase in resistance inside a battery due to high electronic conductivity.

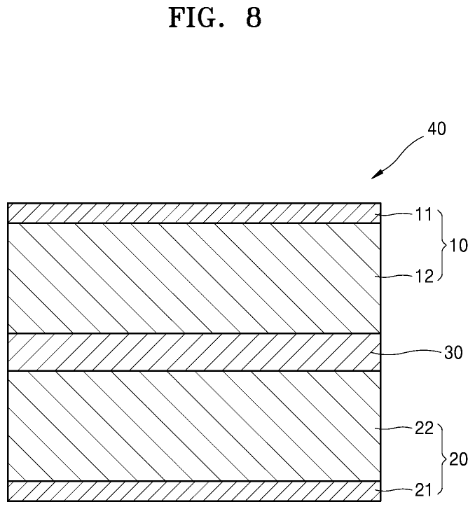

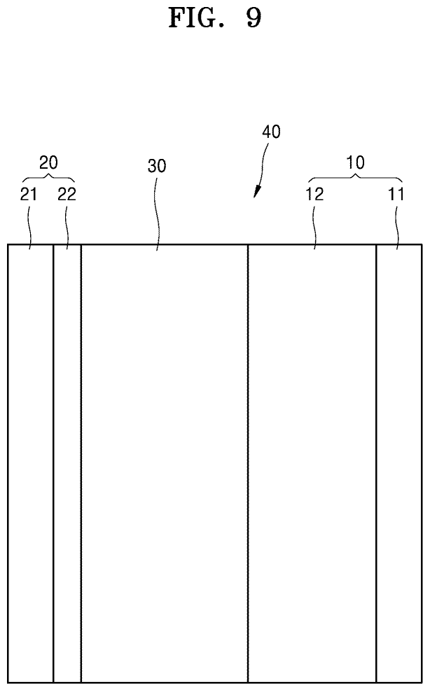

FIG. 8 is a schematic cross-sectional view of a multilayer ceramic capacitor (MLC) according to an embodiment.

Referring to FIG. 8, a positive electrode 110 may be formed by disposing positive active material layers 112 on both sides of a positive current collector 111. A negative electrode 120 may be formed by stacking negative active material layers 122 on both sides of a negative current collector 121. A composite solid-state electrolyte 130 according to an embodiment may be disposed between the positive electrode 110 and the negative electrode 120. External electrodes 140 may be formed on both ends of a battery body 150. The external electrodes 140 are disposed on the positive electrode 110 and the negative electrode 120, ends of which are exposed to the outside of the battery body 150, thereby serving as external terminals that provide electrical communication between the positive electrode 110 and the negative electrode 120 with an external device. One of a pair of external electrodes 140 may be disposed on the positive electrode 110 exposed to the outside of the battery body 150 at one end, and the other may be disposed on the negative electrode 120 exposed to the outside of the battery body 150 at the other end.

The multilayer ceramic capacitor (MLC) 150 may be prepared by forming a stack structure by sequentially stacking a positive electrode, a solid electrolyte, and a negative electrode, stacking the stack structure in multiple layers, and simultaneously heat-treating the stack structures.

Hereinafter, a method of preparing a multilayer ceramic capacitor according to an embodiment will be described in detail.

First, a composite solid-state electrolyte-forming composition, prepared by mixing a first solid-state electrolyte precursor including a cubic garnet phase and a pyrochlore phase, and a second solid-state electrolyte precursor including a glass phase, may be applied to a substrate and dried to form a composite solid-state electrolyte precursor film. The composite solid-state electrolyte precursor film may include i) the amorphous first solid-state electrolyte precursor and ii) the glass-phase second solid-state electrolyte precursor.

When the composite solid-state electrolyte precursor film is in a free standing state, the substrate may be omitted.

A positive electrode-forming composition may be printed on the substrate and the composite solid-state electrolyte precursor film disposed on the substrate to form a positive electrode.

The positive electrode-forming composition may include a positive active material and a binder. In this regard, the positive active material and the binder may be identical to those of the secondary battery such as the all-solid secondary battery may be used. In addition, the positive electrode-forming composition may include a composition for forming the composite solid-state electrolyte according to an embodiment, i.e., i) the amorphous first solid-state electrolyte precursor and ii) the glass-phase second solid-state electrolyte precursor.

Subsequently, a positive current collector and a positive electrode may be formed on the other side of the positive electrode on which the composite solid-state electrolyte precursor film is formed to prepare a substrate/composite solid-state electrolyte precursor film/positive electrode/positive current collector/positive electrode stack structure. The positive current collector may be formed, for example, by printing a positive current collector composition.

Separately, a negative electrode-forming composition may be printed on the substrate and the composite solid-state electrolyte precursor film disposed on the substrate to form a negative electrode.

The negative electrode-forming composition may include a negative active material and a binder. In this regard, the binder may be identical to that used in the all-solid secondary battery.

The above-described positive electrode-forming composition and negative electrode-forming composition may include a solvent.

A negative current collector and a negative electrode may be formed on the other side of the negative electrode on which the composite solid-state electrolyte precursor film is formed to prepare a substrate/composite solid-state electrolyte precursor film/negative electrode/negative current collector/negative electrode stack structure. The negative current collector may be formed, for example, by printing a negative current collector composition.

The substrate may be separated and removed from the substrate/composite solid-state electrolyte precursor film/positive electrode/positive current collector/positive electrode stack structure. As a result, a composite solid-state electrolyte precursor film structure A from which the substrate is removed is obtained. The substrate may be separated and removed from the substrate/composite solid-state electrolyte precursor film/negative electrode/negative current collector/negative electrode stack structure. As a result, a composite solid-state electrolyte precursor film structure B from which the substrate is removed is obtained. The composite solid-state electrolyte precursor film structure A from which the substrate is removed and the composite solid-state electrolyte precursor film structure B from which the substrate is removed may be stacked and pressed to prepare a battery assembly.

Each of the positive current collector composition and the negative current collector composition may include a metal, a conductive oxide, or a combination thereof, and the metal may be copper, aluminum, nickel, silver, gold, or an alloy thereof. For example, aluminum may be used as the positive current collector, and copper may be used as the negative current collector.

Subsequently, the pressed battery assembly may be cut. In this regard, a cutting size of the battery assembly may vary according to the capacity of the multilayer ceramic capacitor, and the battery assembly may be cut to a width of about 5 mm to about 15 mm, e.g., 10 mm, and a length of about 5 mm to about 15 mm, e.g., 10 mm. The cutting process may be omitted.

The structure obtained according to the process may be co-sintered to prepare a unit cell including a positive electrode/current collector/positive electrode/composite solid-state electrolyte/negative electrode/current collector/negative electrode structure.

The co-sintering may be performed, for example, at 550° C. or less. While the co-sintering process is performed, the composite solid-state electrolyte precursor film including the amorphous first solid-state electrolyte precursor and the glass-phase second solid-state electrolyte precursor may be converted into the composite solid-state electrolyte including the first solid-state electrolyte including the cubic garnet phase and the pyrochlore phase and the second solid-state electrolyte including the glass phase.

The multilayer ceramic capacitor according to an embodiment may be prepared by stacking a plurality of unit cells obtained according to the above-described process, and forming external electrodes.

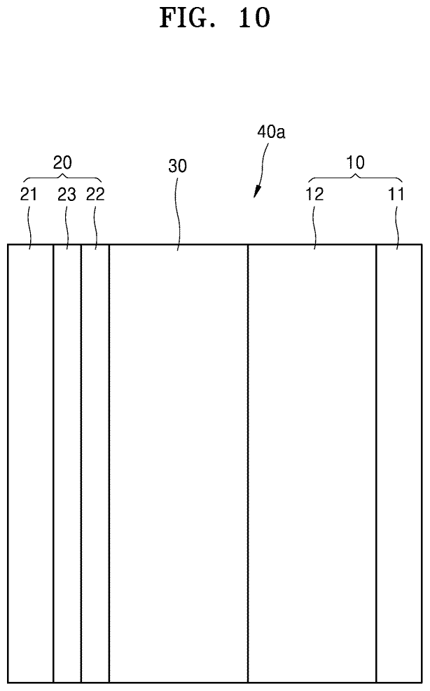

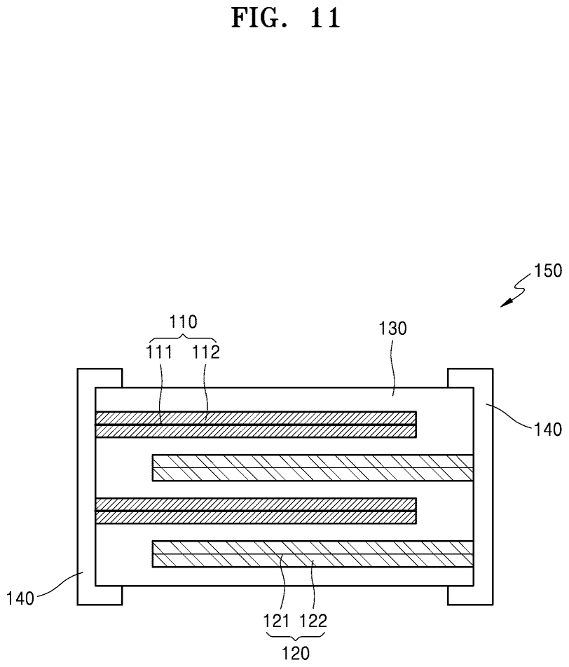

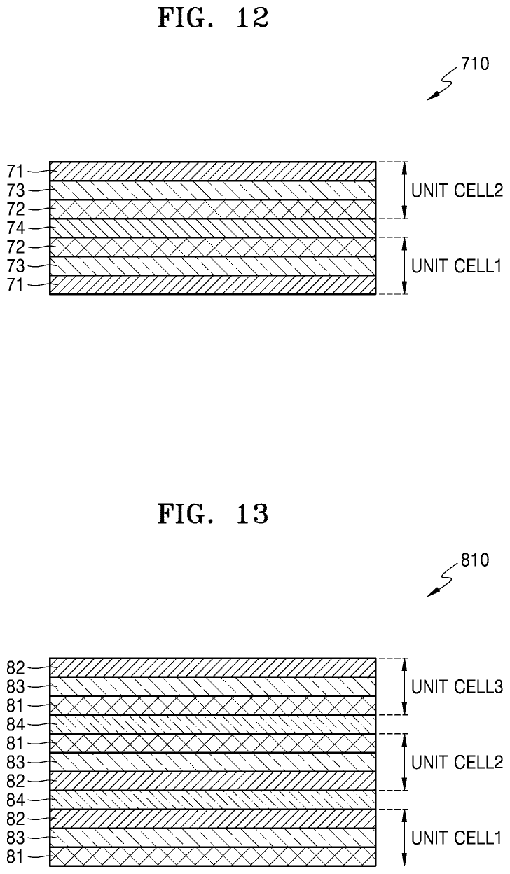

FIGS. 9 and 10 schematically illustrate cross-sectional structures of multilayer ceramic capacitors according to an embodiment.

As shown in FIG. 9, in a multilayer ceramic capacitor 710, Unit Cell 1 and Unit Cell 2 are stacked via an internal current collector layer 74. Each of Unit Cell 1 and Unit Cell 2 is formed of a positive electrode 71, a solid electrolyte layer 73, and a negative electrode 72 sequentially stacked. Unit Cell 1 and Unit Cell 2, and the internal current collector layer 74 are stacked such that the negative electrode 72 of Unit Cell 2 is disposed on one side (upper surface of FIG. 9) of the internal current collector layer 74 and the negative electrode 72 of Unit Cell 1 is disposed on the other side (lower surface of FIG. 9) of the internal current collector layer 74. Although the internal current collector layer 74 is disposed between the negative electrode 72 of Unit Cell 1 and the negative electrode 72 of Unit Cell 2 in FIG. 9, the internal current collector layer 74 may be diposed between each positive electrode 71 of Unit Cell 1 and Unit Cell 2. The internal current collector layer 74 may include an electron-conductive material. The internal current collector layer 74 may further include an ion-conductive material. By further including the ion-conductive material, voltage stabilization characteristics may be improved. Because the electrodes disposed on both sides of the internal current collector layer 74 are the same in the multilayer ceramic capacitor 710, a monopolar multilayer ceramic capacitor 710 in which a plurality of unit cells are connected in parallel may be obtained by disposing the internal current collector layer 74 therebetween. As a result, a high-capacity multilayer ceramic capacitor 710 may be obtained. Because the internal current collector layer 74 disposed between Unit Cell 1 and Unit Cell 2 includes an electron-conductive material in the multilayer ceramic capacitor 710, two adjacent unit cells may be electrically connected in parallel and the positive electrode 71 or the negative electrode 72 may be ion conductively connected to each other in the two adjacent unit cells. Accordingly, the potential of the adjacent positive electrode 71 or negative electrode 72 may be leveled via the internal current collector layer 74, and thus a stable output voltage may be obtained. Also, unit cells constituting the multilayer ceramic capacitor 710 may be electrically connected to each other in parallel without an external current collecting member such as a tab. As a result, a multilayer ceramic capacitor 710 having excellent space utilization and economic feasibility may be obtained. Referring to FIG. 10, a stack structure may include a positive electrode 81, a negative electrode 82, a solid electrolyte layer 83, and an internal current collector layer 84. The stack structure may be stacked and thermally pressed to obtain a multilayer ceramic capacitor stack structure 810. The positive electrode 81 may be formed as a sheet for a positive electrode. The negative electrode 82 may be formed as two sheets for a negative electrode.

Hereinafter, the disclosure will be described in more detail with reference to the following examples and comparative examples. However, the disclosure is not limited thereto.

### Preparation of Amorphous First Solid-state Electrolyte Precursor

### Preparation Example 1: Synthesis of Amorphous Li_{6.5}La_{2.4}Zr_{1.2}Ta_{0.4}O₁₂

La₂O₃, ZrO₂, and Ta₂O₅ were mixed in stoichiometric amount, followed by a solid phase reaction performed by heat treatment at 1250° C. for 48 hours to prepare a precursor having a pyrochlore crystal phase (La_{2.4}Zr_{1.2}Ta_{0.4}O₁₂).

La_{2.4}Zr_{1.2}Ta_{0.4}O₁₂ having the pyrochlore crystal phase was mixed with a lithium precursor Li₂O. The lithium precursor Li₂O was used in excess at about 1.2 times a stoichiometric amount required to obtain amorphous Li_{6.5}La_{2.4}Zr_{1.2}Ta_{0.4}O₁₂. The mixture was added to a high-energy ball mill and dry-milled in an inert atmosphere for 15 hours to prepare amorphous Li_{6.5}La_{2.4}Zr_{1.2}Ta_{0.4}O₁₂. In the high-energy ball milling process, an internal temperature of a ball mill was 100° C. or greater. The product was obtained in a powder state with an average particle diameter (D50) of about 100 nm.

### Preparation of Composite Solid-State Electrolyte

### Example 1

Li_{6.5}La_{2.4}Zr_{1.2}Ta_{0.4}O₁₂, as the amorphous first solid-state electrolyte precursor prepared in Preparation Example 1, was mixed with glass powder of Li₂O, SiO₂, and B₂O₃ in a mixing molar ratio of 50:33.3:16.7. The mixture was sintered with a pressure under atmospheric conditions at 450° C. for 1 hour at 250 MPa to prepare a sintered product of a composite solid-state electrolyte having a thickness of about 500 μm. A mixing volume ratio of the amorphous first solid-state electrolyte precursor to the glass powder was 95:5.

The composite solid-state electrolyte obtained according to the process included a composite phase including a crystal phase (cubic garnet) and a glass phase.

### Example 2

A composite solid-state electrolyte was prepared in the same manner as in Example 1, except that the mixing volume ratio of the amorphous first solid-state electrolyte precursor obtained in Preparation Example 1 to the glass powder was 90:10.

### Example 3

A composite solid-state electrolyte was prepared in the same manner as in Example 1, except that the mixing volume ratio of the amorphous first solid-state electrolyte precursor obtained in Preparation Example 1 to the glass powder was 80:20.

### Comparative Example 1

Commercially available Li_{6.5}La₃Zr_{1.5}Ta_{0.5}O₁₂ powder having a garnet-type crystal structure (cubic phase) (Toshima, LLZ powder, hereinafter, referred to as C-LLZTO) was sintered with a pressure under atmospheric conditions at 450° C. for 1 hour at 250 MPa to prepare a sintered product having a thickness of about 500 μm.

### Comparative Example 2

A composite solid-state electrolyte was prepared in the same manner as in Example 1, except that C-LLZTO of Comparative Example 1 was used instead of the amorphous first solid-state electrolyte precursor obtained in Preparation Example 1 and a mixing volume ratio of the C-LLZTO of Comparative Example 1 to the glass powder was 96:4. As the glass powder, the same glass powder as in Example 1 was used.

### Comparative Example 3

A composite solid-state electrolyte was prepared in the same manner as in Example 1, except that a mixing volume ratio of the C-LLZTO of Comparative Example 1 to the glass powder was 90:10. In this regard, glass powder identical to that of Example 1 was used.

### Comparative Example 4

A composite solid-state electrolyte was prepared in the same manner as in Example 1, except that a mixing volume ratio of the amorphous first solid-state electrolyte precursor obtained in Preparation Example 1 to the glass powder was 50:50.

### Evaluation Example 1: X-Ray Diffraction Analysis

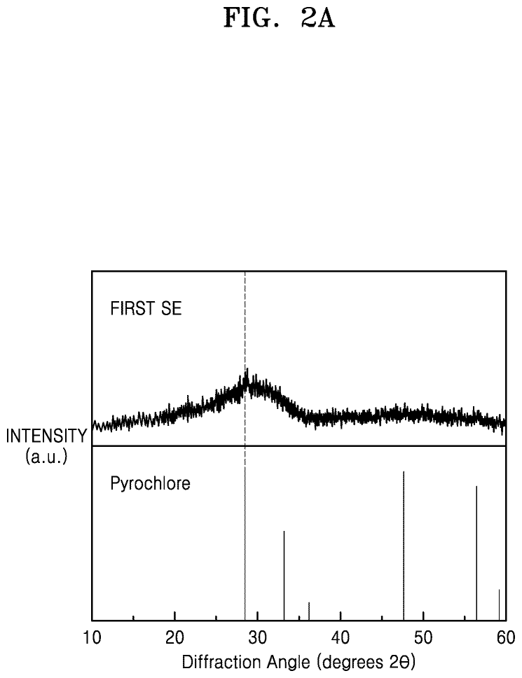

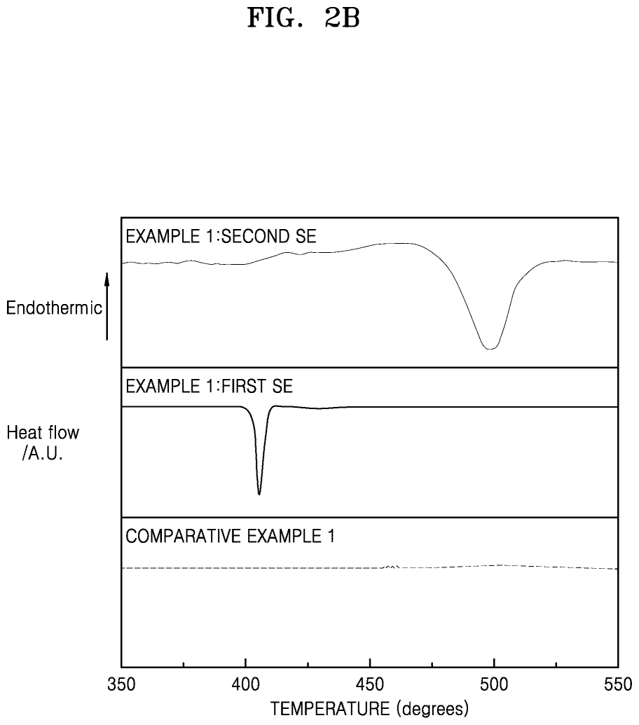

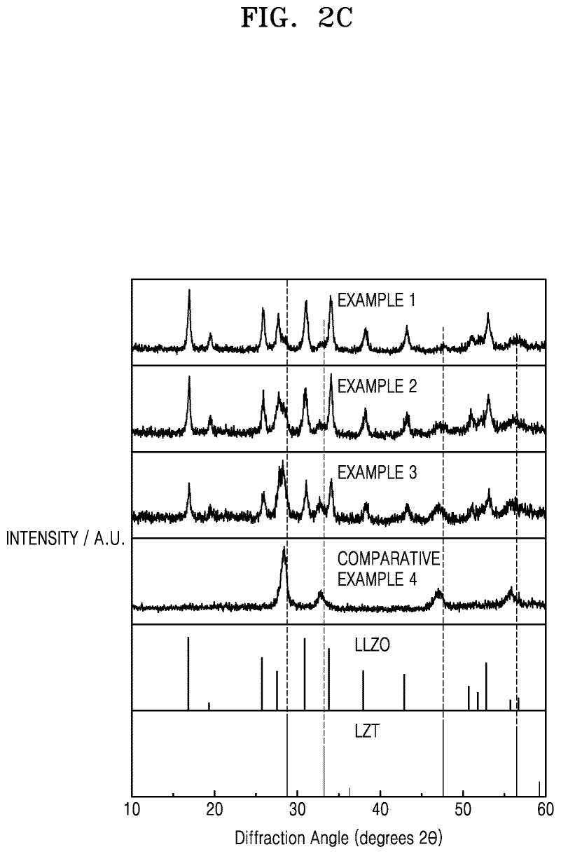

The XRD spectrum of the amorphous first solid-state electrolyte precursor prepared in Preparation Example 1 is shown in FIG. 2A. The XRD spectrum was measured by X'pert pro (PANalytical) using Cu Kα radiation (1.54056 angstroms, Å).

Based on FIG. 2A, it was confirmed that the first solid-state electrolyte precursor obtained in Preparation Example 1 was substantially amorphous.

### Evaluation Example 2: Differential Scanning Calorimetry (DSC) Analysis

The amorphous first solid-state electrolyte precursor and the glass phase second solid-state electrolyte precursor used in Example 1 were analyzed by DSC, and the results are shown in FIG. 2B.

Referring to FIG. 2B, an exothermic peak was not observed in the solid-state electrolyte of Comparative Example 1 due to a garnet crystal phase. An exothermic peak of the first solid-state electrolyte was observed at a lower temperature than that of the second solid-state electrolyte, indicating that the first solid-state electrolyte has a crystallization temperature that is less than a crystallization temperature of the second solid-state electrolyte.

### Evaluation Example 3: X-Ray Diffraction Analysis

XRD spectra of sintered products of the composite electrolytes prepared in Examples 1 to 3 and Comparative Example 4 were measured, and the results are shown in FIG. 2C. In FIG. 2C, LLZTO indicates results of LLZTO (Li_{6.5}La_{2.4}Zr_{1.2}Ta_{0.4}O₁₂) having a cubic garnet phase, and LZT indicates results of LZT (La_{2.4}Zr_{1.2}Ta_{0.4}O₇) having a pyrochlore phase.

The XRD spectra were measured by X'pert pro (PANalytical) using Cu Kα radiation (1.54056 Å).

As show in FIG. 2C, the composite solid-state electrolyte of Example 1 included the cubic garnet crystal phase as a main phase and the pyrochlore phase in a small amount, and peaks related to the pyrochlore phase LZT (La_{2.4}Zr_{1.2}Ta_{0.4}O₇) were observed at diffraction angles of 28.349°2θ(crystal plane (111)), 47.14°2θ(crystal plane (220)), and 55.93°2θ(crystal plane (311)).

The composite solid-state electrolyte of Comparative Example 4 exhibited diffraction angle characteristics different from the composite solid-state electrolyte of Example 1. Based thereon, it was confirmed the mixing volume ratio of the first solid-state electrolyte precursor obtained in Preparation Example 1 to the glass powder played an important role in formation of the composite phase of the composite solid-state electrolyte.

### Evaluation Example 4: Measurement of Ionic Conductivity

Gold (Au) electrodes were deposited as shielding electrodes on both sides of pellets of the composite solid-state electrolytes of Examples 1 to 3, the solid-state electrolyte of Comparative Example 1, and the composite solid-state electrolytes prepared in Comparative Examples 2 to 4 by sputtering. Impedance of each of the samples provided with the shielding electrodes on both sides was measured by an impedance analyzer (Solartron 1400A/1455A) by a 2-probe method. A frequency range was about 1 hertz (Hz) to about 1 MHZ, and an amplitude voltage was 10 millivolts (mV). The impedance was measured under dry atmospheric conditions at 25° C. Resistance was calculated from an arc of a Nyquist plot with respect to the impedance measurement results, and ionic conductivity was calculated therefrom by correcting for electrode area and pellet thickness, and the results are shown in Table 1.

A total resistance (Rtotal) was obtained from the impedance results, and conductivity values may be calculated therefrom by correcting for electrode area and pellet thickness.

As shown in Table 1, the solid-state electrolyte of Comparative Example 1 includes LLZTO having the garnet-type crystal structure (cubic phase) and exhibited a very low ionic conductivity.

The composite solid-state electrolytes of Comparative Examples 2 and 3 exhibited low relative density of about 68% in the case where the amount of the second solid-state electrolyte was 4 vol % or 10 vol %, respectively, based on the total volume of the composite solid-state electrolyte.

Unlike Comparative Examples 1 to 4, the composite solid-state electrolytes of Examples 1 to 3 had increased conductivity and density because the amorphous first solid-state electrolyte formed an interface close to the second solid-state electrolyte and formation of the composite proceeded while the amorphous first solid-state electrolyte was crystallized.

### Evaluation Example 5: SEM Analysis

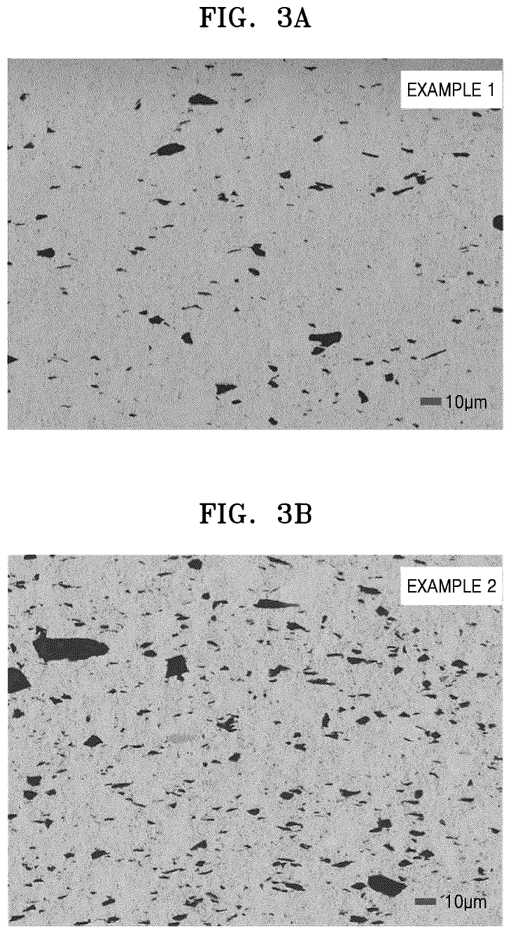

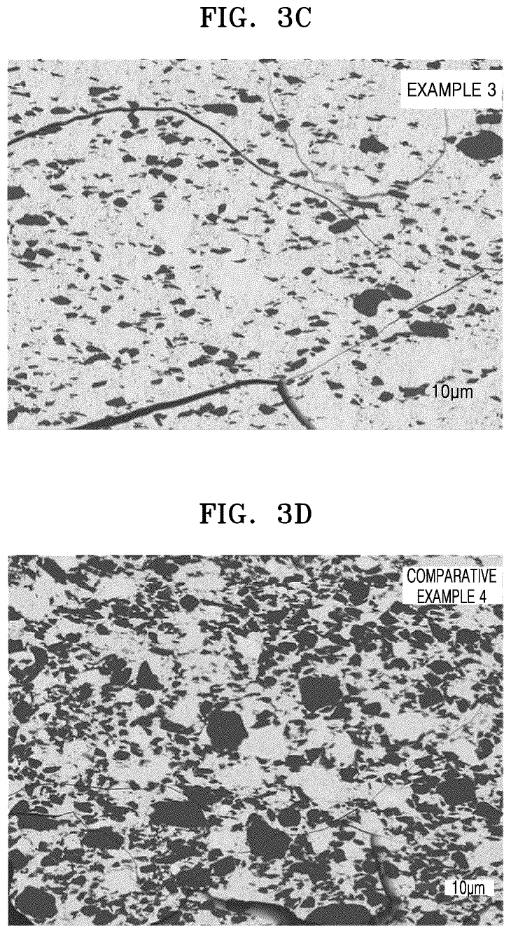

Cross-sections of the composite solid-state electrolytes prepared in Examples 1 to 3 and Comparative Example 4 were evaluated by SEM analysis, and the results are shown in FIGS. 3A to 3D. As a scanning electron microscope (SEM), SU-8030 produced by Hitachi was used.

Referring to FIGS. 3A to 3C, it was confirmed that the second solid-state electrolyte was dispersed in the highly conductive first solid-state electrolyte matrix and a low-temperature dense structure was formed in the composite solid-state electrolytes of Examples 1 to 3 and the composite solid-state electrolyte of Comparative Example 4.

As the amount of the second solid-state electrolyte increased to 50% in the composite solid-state electrolyte of Comparative Example 4, it was confirmed that a large amount of the second solid-state electrolyte was dispersed in the first solid-state electrolyte matrix as shown in FIG. 3D.

### Evaluation Example 6: SEM-EDS Analysis

The composite solid-state electrolyte prepared in Example 1 was analyzed by scanning electron microscopy/energy dispersive X-ray spectroscopy (SEM-EDS). Spectra 300 (Thermo Fisher) was used for SEM-EDS.

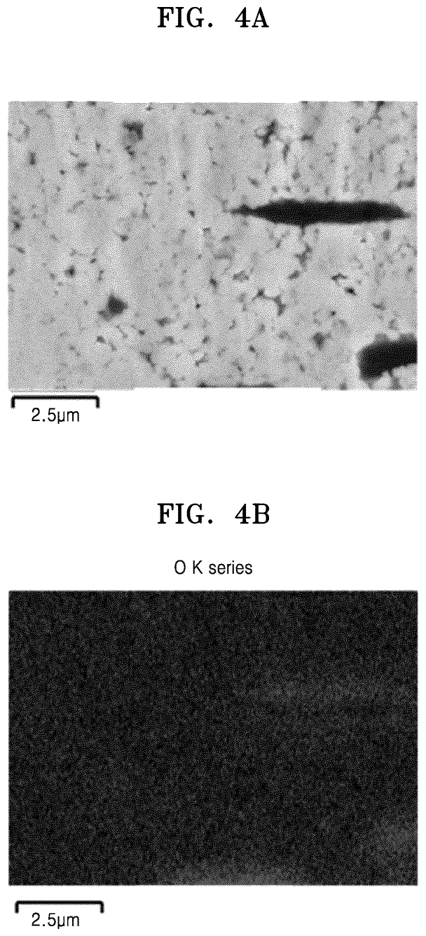

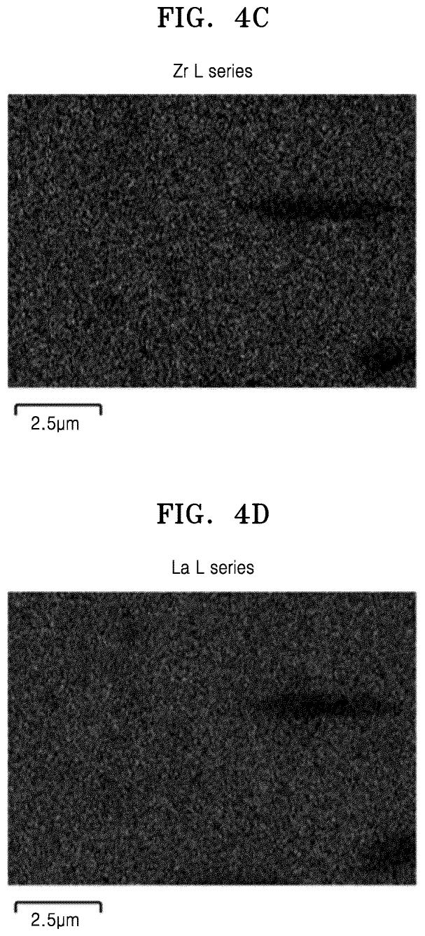

The SEM-EDS analysis results are shown in FIGS. 4A to 4D.

Based thereon, the presence of zirconium and lanthanum of the first solid-state electrolyte was confirmed.

### Evaluation Example 7: Relative Density

Relative densities of the composite solid-state electrolytes of Examples 1 to 3, the solid-state electrolyte of Comparative Example 1, and the composite solid-state electrolytes prepared in Comparative Examples 2 to 4 were measured and the results are shown in Table 1. The relative density of pellets was calculated by a ratio of measured density to theoretical density. In this regard, the measured density was obtained by using a density meter based on Archimedes' principle or apparent volume and weight of sintered pellets, and the theoretical density of pellets was measured by a measurement method using apparent density. A density was calculated by considering a mixing ratio of theoretical densities of Ta-doped LLZO and Li—B—Si—O glass, i.e., 5.5 g/cm³ and 2.4 g/cm³, as 100%.

TABLE 1

| Category | Ionic conductivity (S/cm] | Relative density (%) |
|---|---|---|
| Example 1 | 4.13 × 10⁻⁵ | 83.4 |
| Example 2 | 2.06 × 10⁻⁴ | 85.6 |
| Example 3 | 5.29 × 10⁻⁴ | 90.4 |
| Comparative | 5.21 × 10⁻⁷ | 67.0 |
| Example 1 | | |
| Comparative | 2.97 × 10⁻⁷ | 68.0 |
| Example 2 | | |
| Comparative | 1.05 × 10⁻⁷ | 67.3 |
| Example 3 | | |
| Comparative | 1.83 × 10⁻⁸ | 93.7 |
| Example 4 | | |

Referring to Table 1, the composite solid-state electrolytes of Examples 1 to 3 had higher relative density than those of Comparative Examples 1 to 3.

According to an embodiment, a composite solid-state electrolyte including the first solid-state electrolyte having a cubic garnet phase and a pyrochlore phase and a second solid-state electrolyte having a glass phase may be provided. By setting the sintering temperature of the composite solid-state electrolyte between the crystallization temperature of the first solid-state electrolyte and the crystallization temperature of the second solid-state electrolyte, the composite solid-state electrolyte may have increased conductivity and density at a low temperature. By using the composite solid-state electrolyte, sintering may be performed at a low temperature and a lithium battery having improved energy density may be prepared. By using the solid-state electrolyte, a lithium battery having improved cycle characteristics may be provided.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A composite solid-state electrolyte comprising:
a first solid-state electrolyte comprising a cubic garnet phase and a pyrochlore phase; and
a second solid-state electrolyte comprising a glass phase,
wherein a volume of the first solid-state electrolyte is greater than a volume of the second solid-state electrolyte, based on a total volume of the composite solid-state electrolyte.

2. The composite solid-state electrolyte of claim 1, wherein a crystallization temperature T1 of the first solid-state electrolyte is less than a crystallization temperature T2 of the second solid-state electrolyte.

3. The composite solid-state electrolyte of claim 1, wherein a crystallization temperature of the first solid-state electrolyte is about 300° C. to about 450° C., and
a crystallization temperature of the second solid-state electrolyte is about 450° C. to about 600° C.

4. The composite solid-state electrolyte of claim 1, wherein the composite solid-state electrolyte includes a heat treatment product of a composite solid-state electrolyte-forming composition comprising a first solid-state electrolyte precursor and a second solid-state electrolyte precursor, and a heat treatment temperature T of the composite solid-state electrolyte-forming composition is 550° C. or less, and
the crystallization temperature T1 of the first solid-state electrolyte, the heat treatment temperature T of the composite solid-state electrolyte-forming composition, and the crystallization temperature T2 of the second solid-state electrolyte satisfy Expression 1:
$$T 1 < T < T 2. \qquad Expression 1$$

5. The composite solid-state electrolyte of claim 1, wherein a crystal phase of the first solid-state electrolyte has a size of about 50 nanometers to about 50 micrometers.

6. The composite solid-state electrolyte of claim 1, wherein the composite solid-state electrolyte has an ionic conductivity of about 1×10⁻⁶ siemens per centimeter to about 1×10⁻³ siemens per centimeter and a relative density of about 80% to about 95%, based on a theoretical density of the composite solid-state electrolyte.

7. The composite solid-state electrolyte of claim 1, wherein an amount of the first solid-state electrolyte is greater than 50 volume percent and 99 volume percent or less, based on a total volume of the composite solid-state electrolyte.

8. The composite solid-state electrolyte of claim 1, wherein the first solid-state electrolyte comprises a compound represented by Formula 1:
(LiₓAₐ)(La_{y}B′_{b})(Zr_{z}C′_{c})O₁₂ Formula 1
wherein in Formula 1, A is a monovalent cation, a divalent cation, a trivalent cation, or a combination thereof,
B′ is a monovalent cation, a divalent cation, a trivalent cation, or a combination thereof,
C′ is a monovalent cation, a divalent cation, a trivalent cation, a tetravalent cation, a pentavalent cation, a hexavalent cation, or a combination thereof,
6≤x≤8, 0≤a≤2, 2≤y≤3, 0≤b≤1, 0<z≤2, and 0≤c≤2.

9. The composite solid-state electrolyte of claim 8, wherein the first solid-state electrolyte comprises a compound represented by Formula 2, a compound represented by Formula 3, or a combination thereof:
Liₓ(La_{y}B′_{b})(Zr_{z}C′_{c})O₁₂ Formula 2
wherein in Formula 2, B′ comprises at least one of calcium, strontium, cesium, or barium,
C′ comprises at least one of aluminum, tungsten, niobium or tantalum,
6≤x≤8, 2≤y≤3, 0<z≤2, 0<b≤1, and 0.01≤c≤2, or
(LiₓAₐ)(La_{y})(Zr_{z})O₁₂ Formula 3
wherein in Formula 3, A comprises at least one of gallium or aluminum, 6≤x≤8, 0≤a≤2, 2≤y≤3, and 0<z≤2.

10. The composite solid-state electrolyte of claim 8, wherein the solid-state electrolyte represented by Formula 1 is a compound represented by Formula 4:
Li₃₊ₓLa₃Zr₂ₐC′ₐO₁₂ Formula 4
wherein, in Formula 4, C′ may include at least one of aluminum, tungsten, niobium or tantalum, 3≤x≤5 and 0≤a≤0.7.

11. The composite solid-state electrolyte of claim 1, wherein the second solid-state electrolyte is an oxide glass comprising lithium, oxygen, and at least one of germanium, silicon, boron, or phosphorus.

12. The composite solid-state electrolyte of claim 1, wherein the second solid-state electrolyte comprises a glass comprising SiO₂, B₂O₃, and Li₂O,
wherein an amount of the Li₂O is 20 mole percent to 75 mole percent, an amount of the SiO₂ is greater than 0 mole percent to 70 mole percent, and an amount of the B₂O₃ is greater than 0 mole percent to 60 mole percent.

13. The composite solid-state electrolyte of claim 1, wherein, when analyzed by X-ray diffraction using CuKa radiation, peaks of the pyrochlore phase are observed at diffraction angles of about 27.5°2θ to about 29°2θ, about 32°2θ to about 33.5°2θ, about 46.5°2θ to about 48°2θ, and about 55°2θ to about 56.5°2θ.

14. A lithium battery comprising:
a positive electrode;
a negative electrode; and
an electrolyte layer disposed between the positive electrode and the negative electrode,
wherein at least one of the positive electrode, the negative electrode, or the electrolyte layer comprises the composite solid-state electrolyte of claim 1.

15. The lithium battery of claim 14, wherein the positive electrode comprises:
a first solid-state electrolyte including a cubic garnet phase and a pyrochlore phase; and
a second solid-state electrolyte including a glass phase,
wherein a volume of the first solid-state electrolyte is greater than a volume of the second solid-state electrolyte, based on a total volume of the composite solid-state electrolyte.

16. A method of preparing a composite solid-state electrolyte comprising a first solid-state electrolyte and a second solid-state electrolyte,
wherein the first solid-state electrolyte comprises a cubic garnet phase and a pyrochlore phase, and the second solid-state electrolyte comprises a glass phase, and
wherein a volume of the first solid-state electrolyte is greater than a volume of the second solid-state electrolyte, based on a total volume of the composite solid-state electrolyte, the method comprising:
mixing a first solid-state electrolyte precursor comprising an amorphous phase and a second solid-state electrolyte precursor comprising a glass phase to prepare a composite solid-state electrolyte-forming composition; and
heat-treating the composite solid-state electrolyte-forming composition to prepare the composite solid-state electrolyte.

17. The method of claim 16, wherein the second solid-state electrolyte comprising a glass phase is an oxide glass comprising lithium, oxygen, and at least one of germanium, silicon, boron, or phosphorus.

18. The method of claim 16, wherein the second solid-state electrolyte is a glass comprising SiO₂, B₂O₃, and Li₂O,
wherein an amount of the Li₂O is about 20 mole percent to about 75 mole percent, an amount of the SiO₂ is greater than 0 mole percent to about 70 mole percent, and an amount of the B₂O₃ is greater than 0 mole percent to about 60 mole percent.

19. The method of claim 16, wherein the heat-treating of the composite solid-state electrolyte-forming composition is performed at a temperature greater than a crystallization temperature of a first solid-state electrolyte precursor and less than a crystallization temperature of a second solid-state electrolyte precursor, and
the heat-treating of the composite solid-state electrolyte-forming composition is performed at 550° C. or less.

20. The composite solid-state electrolyte of claim 1, wherein the ratio of the cubic garnet phase to the pyrochlore phase is about 99.5:0.5 to about 3:2.
